(19) United States
(12) Patent Application Publication
(10) Pub. No.: US 2026/0270392 A1
(43) Pub. Date: Sep. 10, 2026

(54) Method and Apparatus for Cross Component Prediction with Blending in Video Coding Systems

(71) Applicant: MEDIATEK INC., Hsinchu City (TW)

(72) Inventors: Man-Shu CHIANG, Hsinchu City (TW); Chih-Wei HSU, Hsinchu City (TW)

(21) Appl. No.: 18/873,524

(22) PCT Filed: Jun. 14, 2023
(86) PCT No.: PCT/CN2023/100279

§ 371 Date: Dec. 10, 2024

Related U.S. Application Data
(60) Provisional application No. 63/352,343, filed on Jun. 15, 2022.

(51) Int. Cl. H04N 19/105; H04N 19/159; H04N 19/186; H04N 19/196

(52) U.S. Cl. CPC H04N 19/105; H04N 19/159; H04N 19/186; H04N 19/196

(57) ABSTRACT

A method and apparatus for inter CCLM prediction. According to the method, one or more model parameters for one or more cross-colour models associated with the first-colour block and the second-colour block are determined. A cross-component predictor is derived for the second-colour block by applying said one or more cross-colour models to corresponding reconstructed or predicted first-colour pixels of the first-colour block. A final predictor is derived for the second-colour block by using the cross-component predictor or combining the cross-component predictor and a target-mode predictor for the second-colour block. The second-colour block is encoded or decoded by using prediction data comprising the final predictor.

### CROSS REFERENCE TO RELATED APPLICATIONS

The present invention is a non-Provisional application of and claims priority to U.S. Provisional Patent Application No. 63/352,343, filed on Jun. 15, 2022. The U.S. Provisional Patent Application is hereby incorporated by reference in its entirety.

### FIELD OF THE INVENTION

The present invention relates to video coding system. In particular, the present invention relates to a new video coding tool by blending a cross-component linear model predictor and an inter mode predictor in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264, VVC or any other video coding standard.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

In the present disclosure, various new coding tools are presented to improve the coding efficiency beyond the VVC. In particular, a new coding tool relates to inter CCLM, which may blend a cross-colour LM predictor and a non-intra mode predictor.

### BRIEF SUMMARY OF THE INVENTION

A method and apparatus for prediction in video coding system are disclosed. According to the method, input data associated with a current block comprising a first-colour block and a second-colour block are received, wherein the input data comprises pixel data for the current block to be encoded at an encoder side or encoded data associated with the current block to be decoded at a decoder side, and wherein the first-colour block is coded in a target mode wherein the target mode refers to an inter mode or an intra block copy mode. One or more model parameters for one or more cross-colour models associated with the first-colour block and the second-colour block are determined. A cross-component predictor is derived for the second-colour block by applying said one or more cross-colour models to corresponding reconstructed or predicted first-colour pixels of the first-colour block. A final predictor is derived for the second-colour block by using the cross-component predictor or combining the cross-component predictor and a target-mode predictor for the second-colour block. The second-colour block is encoded or decoded by using prediction data comprising the final predictor.

In one embodiment, said one or more model parameters for said one or more cross-colour models are derived by using neighbouring reconstructed first-colour samples of the first-colour block and neighbouring reconstructed second-colour samples of the second-colour block. In another embodiment, said one or more model parameters for said one or more cross-colour models are derived by using neighbouring predicted first-colour samples of the first-colour block and neighbouring predicted second-colour samples of the second-colour block.

In one embodiment, the cross-component predictor is selected from a set of cross-component modes. For example, the set of cross-component modes may comprise a combination of all or any of CCLM_LT, CCLM_L, CCLM_T, MMLM_LT, MMLM_L, and MMLM_T modes. The cross-component predictor can be selected from the set of cross-component modes according to an implicit rule. In one embodiment, the implicit rule is related to block width, block height, or block area of the current block. In another embodiment, the implicit rule is inferred as predefined. In yet another embodiment, the cross-component predictor is selected according to one or more explicit indexes.

In one embodiment, the target-mode predictor is derived using Combined Inter Merge and Intra Prediction (CIIP), CIIP with Template Matching (CIIP TM), or CIIP with Position Dependent Intra Prediction Combination (CIIP PDPC).

In one embodiment, the first-colour block corresponds to a luma block and the second-colour block corresponds to a chroma block.

In one embodiment, the final predictor for the second-colour block is derived using a weighted sum of the cross-component predictor and the target-mode predictor. In one embodiment, one or more weights for the weighted sum of the cross-component predictor and the target-mode predictor are selected according to a coding mode of one or more neighbouring blocks of the current block. The neighbouring blocks may correspond to a top neighbouring block, a left neighbouring block or both.

In one embodiment, when the current block is coded in a Combined Inter Merge and Intra Prediction (CIIP), one or more flags are signalled or parsed from a bitstream to indicate whether an inter CCLM process is applied to the current block, and wherein the inter CCLM process comprises said deriving the cross-component predictor, said deriving the final predictor and said encoding or decoding the second-colour block by using the prediction data comprising the final predictor. When the inter CCLM process is applied to the current block, the cross-component predictor is inferred to be derived according to CCLM_LT. In another embodiment, when the inter CCLM process is applied to the current block, the cross-component predictor is inferred as a target cross-component mode with a smallest boundary matching cost among a set of candidate cross-component modes.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates an example of directional (angular) modes for Intra prediction.

FIG. 3 illustrates an example of Multiple Reference Line (MRL) intra prediction, where 4 reference lines are used for intra prediction.

FIG. 4A illustrates an example of Intra Sub-Partition (ISP), where a block is partitioned in two subblocks horizontally or vertically.

FIG. 4B illustrates an example of Intra Sub-Partition (ISP), where a block is partitioned in four subblocks horizontally or vertically.

FIG. 5 illustrates an example of processing flow for Matrix weighted Intra Prediction (MIP).

FIG. 6 illustrates the reference region of IBC Mode, where each block represents 64×64 luma sample unit and the reference region depends on the location of the current coded CU.

FIG. 7 shows the relative sample locations of M×N chroma block, the corresponding 2M×2N luma block and their neighbouring samples (shown as filled circles and triangles) of “type-0” content.

FIG. 8A illustrates an example of selected template for a current block, where the template comprises T lines above the current block and T columns to the left of the current block.

FIG. 8B illustrates an example for T=3 and the HoGs (Histogram of Gradient) are calculated for pixels in the middle line and pixels in the middle column.

FIG. 8C illustrates an example of the amplitudes (ampl) for the angular intra prediction modes.

FIG. 9 illustrates an example of the blending process, where two angular intra modes (M1 and M2) are selected according to the indices with two tallest bars of histogram bars.

FIG. 10 illustrates an example of template-based intra mode derivation (TIMD) mode, where TIMD implicitly derives the intra prediction mode of a CU using a neighbouring template at both the encoder and decoder.

FIG. 11 illustrates the neighbouring blocks used for deriving spatial merge candidates for VVC.

FIG. 12 illustrates the possible candidate pairs considered for redundancy check in VVC.

FIG. 13 illustrates an example of temporal candidate derivation, where a scaled motion vector is derived according to POC (Picture Order Count) distances.

FIG. 14 illustrates the position for the temporal candidate selected between candidates C₀ and C₁.

FIG. 15 illustrates the distance offsets from a starting MV in the horizontal and vertical directions according to Merge Mode with MVD (MMVD).

FIG. 16A illustrates an example of the affine motion field of a block described by motion information of two control point (4-parameter).

FIG. 16B illustrates an example of the affine motion field of a block described by motion information of three control point motion vectors (6-parameter).

FIG. 17 illustrates an example of block based affine transform prediction, where the motion vector of each 4×4 luma subblock is derived from the control-point MVs.

FIG. 18 illustrates an example of derivation for inherited affine candidates based on control-point MVs of a neighbouring block.

FIG. 19 illustrates an example of affine candidate construction by combining the translational motion information of each control point from spatial neighbours and temporal.

FIG. 20 illustrates an example of affine motion information storage for motion information inheritance.

FIG. 21 illustrates an example of the weight value derivation for Combined Inter and Intra Prediction (CIIP) according to the coding modes of the top and left neighbouring blocks.

FIG. 22 illustrates an example of the of 64 partitions used in the VVC standard, where the partitions are grouped according to their angles and dashed lines indicate redundant partitions.

FIG. 23 illustrates an example of uni-prediction MV selection for the geometric partitioning mode.

FIG. 24 illustrates an example of bending weight coo using the geometric partitioning mode.

FIG. 25 illustrates an example of GPM blending process according to a discrete ramp function for the blending area around the boundary.

FIG. 26 illustrates an example of GPM blending process used for GPM blending in ECM 4.0.

FIGS. 27A-C illustrate examples of available IPM candidates: the parallel angular mode against the GPM block boundary (Parallel mode, FIG. 27A), the perpendicular angular mode against the GPM block boundary (Perpendicular mode, FIG. 27B), and the Planar mode (FIG. 27C), respectively.

FIG. 27D illustrates an example of GPM with intra and intra prediction, where intra prediction is restricted to reduce the signalling overhead for IPMs and hardware decoder cost.

FIG. 28A illustrates the syntax coding for Spatial GPM (SGPM) before using a simplified method.

FIG. 28B illustrates an example of simplified syntax coding for Spatial GPM (SGPM).

FIG. 29 illustrates an example of template for Spatial GPM (SGPM).

FIG. 30 illustrates an example of the templates for luma and chroma to derive the model parameters and the template-matching distortion.

FIG. 31 illustrates an example of prediction based CCLM to derive prediction for Cb and Cr based on predicted samples of Y according to an embodiment of the present invention.

FIG. 32 illustrates an example of the relationship between the cr prediction, cb prediction and JCCLM predictors.

FIG. 33 illustrates an example of Adaptive Intra-mode selection, where the chroma block is divided into 4 sub-blocks.

FIGS. 34A-C illustrate some possible ways to partition the current block and the weight selection for prediction from CCLM associated with these partitions.

FIG. 35 illustrates an example of boundary samples used to derive the boundary matching cost.

FIG. 36 illustrates an example of Cross-CU LM, where the block has an irregular pattern that no angular intra prediction can provide a good prediction.

FIG. 37 illustrates an example that a luma picture area associated with a node contains irregular patterns and the picture area is divided into various blocks for applying inter or intra prediction.

FIGS. 38A-B illustrate examples of using LM mode to generate the right-bottom region within (FIG. 38A) or outside (FIG. 38B) the current block.

FIG. 39 illustrates a flowchart of an exemplary video coding system that blends a linear model predictor with an inter mode predictor according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The VVC standard incorporates various new coding tools to further improve the coding efficiency over the HEVC standard. Among various new coding tools, some coding tools relevant to the present invention are reviewed as follows.

Intra Mode Coding with 67 Intra Prediction Modes

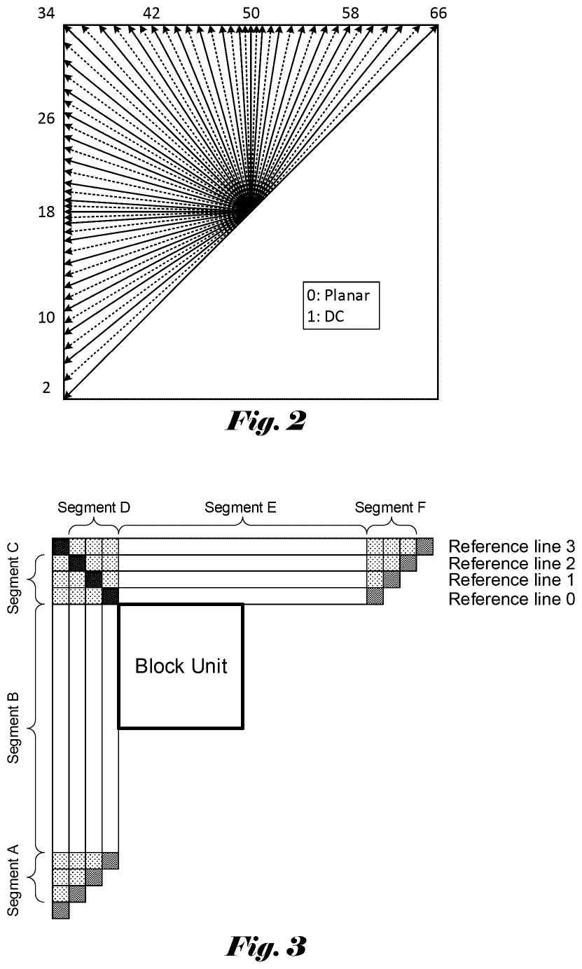

To capture the arbitrary edge directions presented in natural video, the number of directional intra modes in VVC is extended from 33, as used in HEVC, to 65. The new directional (angular) modes not in HEVC are depicted as red dotted arrows in FIG. 2, and the planar and DC modes remain the same. These denser directional intra prediction modes are applied for all block sizes and for both luma and chroma intra predictions.

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes

### Multiple Reference Line Intra Prediction

Multiple reference line (MRL) intra prediction uses more reference lines for intra prediction. In FIG. 3, an example of 4 reference lines is depicted, where the samples of segments A and F are not fetched from reconstructed neighbouring samples but padded with the closest samples from segments B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line idx, which is greater than 0, only include additional reference line modes in MPM list and only signal mpm index without remaining mode. The reference line index is signalled before intra prediction modes, and Planar mode is excluded from intra prediction modes in case that a nonzero reference line index is signalled.

MRL is disabled for the first line of blocks inside a CTU to prevent using extended reference samples outside the current CTU line. Also, PDPC (Position-Dependent Prediction Combination) is disabled when an additional line is used. For MRL mode, the derivation of DC value in DC intra prediction mode for non-zero reference line indices is aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MRL to use the same 3 lines is aligned with CCLM to reduce the storage requirements for decoders.

### Intra Sub-Partitions

The intra sub-partitions (ISP) divides luma intra-predicted blocks vertically or horizontally into 2 or 4 sub-partitions depending on the block size. For example, the minimum block size for ISP is 4×8 (or 8×4). If block size is greater than 4×8 (or 8×4), then the corresponding block is divided by 4 sub-partitions. It has been noted that the M×128 (with M≤64) and 128×N (with N≤64) ISP blocks could generate a potential issue with the 64×64 VDPU (Virtual Decoder Pipeline Unit). For example, an M×128 CU in the single tree case has an M×128 luma TB and two corresponding

$$\frac{M}{2} \times 64$$

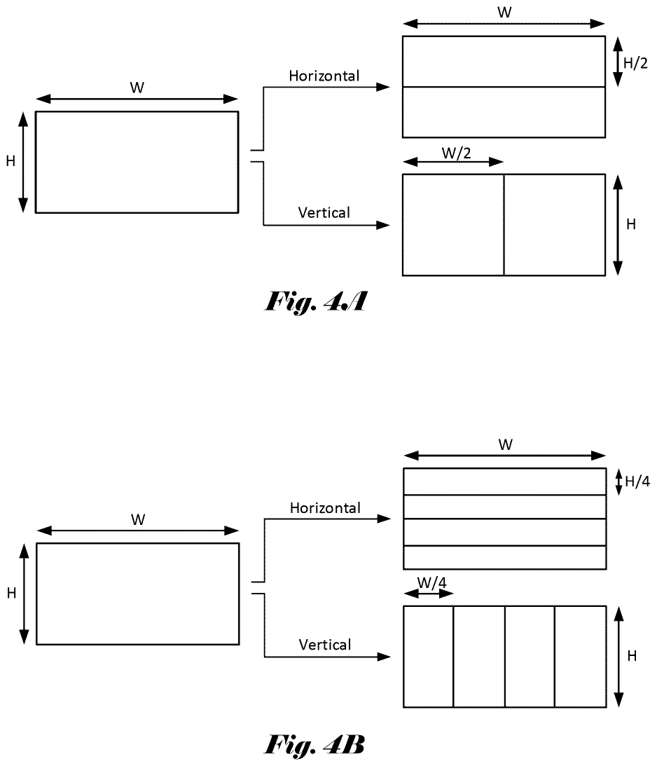

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU size that can use ISP is restricted to a maximum of 64×64. FIG. 4A and FIG. 4B shows examples of the two possibilities. All sub-partitions fulfil the condition of having at least 16 samples.

In ISP, the dependence of 1×N and 2×N subblock prediction on the reconstructed values of previously decoded 1×N and 2×N subblocks of the coding block is not allowed so that the minimum width of prediction for subblocks becomes four samples. For example, an 8×N (N>4) coding block that is coded using ISP with vertical split is partitioned into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks compared to processing 4×4 regular-coded intra blocks.

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed consecutively. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode.

### Matrix Weighted Intra Prediction

Matrix weighted intra prediction (MIP) method is a newly added intra prediction technique in VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, i.e., averaging, matrix vector multiplication and linear interpolation as shown in FIG. 5. One line of H reconstructed neighbouring boundary samples 512 left of the block and one line of W reconstructed neighbouring boundary samples 510 above the block are shown as dot-filled small squares. After the averaging process, the boundary samples are down-sampled to top boundary line 514 and left boundary line 516. The down-sampled samples are provided to the matric-vector multiplication unit 520 to generate the down-sampled prediction block 530. An interpolation process is then applied to generate the prediction block 540.

### Averaging Neighbouring Samples

Among the boundary samples, four samples or eight samples are selected by averaging based on the block size and shape. Specifically, the input boundaries

$${bdry}^{top} and {bdry}^{left}$$

are reduced to smaller boundaries

$${bdry}_{red}^{top} and {bdry}_{red}^{left}$$

by averaging neighbouring boundary samples according to a predefined rule depending on block size. Then, the two reduced boundaries

$${bdry}_{red}^{top} and {bdry}_{red}^{left}$$

are concatenated to a reduced boundary vector bdry_{red} which is thus of size four for blocks of shape 4×4 and of size eight for blocks of all other shapes. If mode refers to the MIP-mode this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6\end{matrix} .$$

### Matrix Multiplication

A matrix vector multiplication, followed by addition of an offset, is carried out with the averaged samples as an input. The result is a reduced prediction signal on a subsampled set of samples in the original block. Out of the reduced input vector bdry_{red}, a reduced prediction signal pred_{red}, which is a signal on the down-sampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix}$$

$${H}_{red} = \{ \begin{matrix}4 & for max ( W , H ) \leq 8 \\ min ( H , 8 ) & for max ( W , H ) > 8\end{matrix}$$

The reduced prediction signal pred_{red} is computed by calculating a matrix vector product and adding an offset:

$${pred}_{red} = A \cdot {bdry}_{red} + b .$$

Here, A is a matrix that has W_{red}·H_{red} rows and 4 columns for W=H=4 and 8 columns for all other cases. b is a vector of size W_{red}·H_{red}. The matrix A and the offset vector b are taken from one of the sets S₀, S₁, S₂. One defines an index idx=idx(W, H) as follows:

$$idx ( W , H ) = \{ \begin{matrix}0 & for W = H = 4 \\ 1 & for max ( W , H ) = 8 \\ 2 & for max ( W , H ) > 8\end{matrix} .$$

Here, each coefficient of the matrix A is represented with 8-bit precision. The set S₀ consists of 16 matrices

$${A}_{0}^{i} ,$$

i∈{0, . . . , 15}, each of which has 16 rows and 4 columns, and 16 offset vectors

$${b}_{0}^{i} ,$$

i∈{0, . . . , 16}, each of size 16. Matrices and offset vectors of that set are used for blocks of size 4×4. The set S, consists of 8 matrices

$${A}_{1}^{i} ,$$

i∈{0, . . . , 7}, each of which has 16 rows and 8 columns, and 8 offset vectors

$${b}_{1}^{i} ,$$

i∈{0, . . . , 7}, each of size 16. The set S₂ consists of 6 matrices

$${A}_{2}^{i} ,$$

i∈{0, . . . , 5}, each of which has 64 rows and 8 columns, and 6 offset vectors b₂ⁱ, i∈{0, . . . , 5}, each of size 64.

### Interpolation

The prediction signal at the remaining positions is generated from the prediction signal on the subsampled set by linear interpolation, which is a single-step linear interpolation in each direction. The interpolation is performed firstly in the horizontal direction and then in the vertical direction, regardless of block shape or block size.

Signalling of MIP Mode and Harmonization with Other Coding Tools For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows

$$isTransposed = predModeIntra \& 1$$

$$modeId = predModeIntra ≫ 1$$

MIP coding mode is harmonized with other coding tools by considering following aspects:
LFNST (Low-Frequency Non-Separable Transform) is enabled for MIP on large blocks. Here, the LFNST transforms of planar mode are used
The reference sample derivation for MIP is performed exactly as for the conventional intra prediction modes
For the up-sampling step used in the MIP-prediction, original reference samples are used instead of down-sampled ones
Clipping is performed before up-sampling and not after up-sampling
MIP is allowed up to 64×64 regardless of the maximum transform size
The number of MIP modes is 32 for sizeId=0, 16 for sizeId=1 and 12 for sizeId=2

### Intra Block Copy

Intra block copy (IBC) is a tool adopted in HEVC extensions on SCC (Screen Content Coding). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR (Adaptive Motion Vector Resolution), the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return a valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP (Advanced Motion Vector Prediction) mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP (History based Motion Vector Prediction), and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### IBC Reference Region

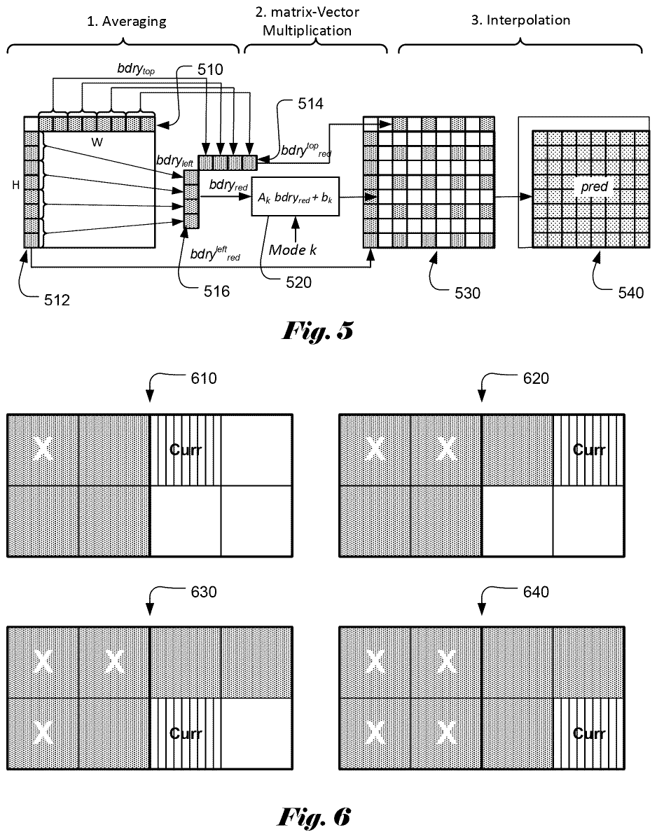

To reduce memory consumption and decoder complexity, the IBC in VVC allows only the reconstructed portion of the predefined area including the region of current CTU and some region of the left CTU. FIG. 6 illustrates the reference region of IBC Mode, where each block represents 64×64 luma sample unit. Depending on the location of the current coded CU within the current CTU, the following applies:
If the current block falls into the top-left 64×64 block of the current CTU (case 610 in FIG. 6), then in addition to the already reconstructed samples in the current CTU, it can also refer to the reference samples in the bottom-right 64×64 blocks of the left CTU, using current picture referencing (CPR) mode. (More details of CPR can be found in JVET-T2002 (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)). The current block can also refer to the reference samples in the bottom-left 64×64 block of the left CTU and the reference samples in the top-right 64×64 block of the left CTU, using CPR mode.
If the current block falls into the top-right 64×64 block of the current CTU (case 620 in FIG. 6), then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If the current block falls into the bottom-left 64×64 block of the current CTU (case 630 in FIG. 6), then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU (case 640 in FIG. 6), it can only refer to the already reconstructed samples in the current CTU, using CPR mode.

This restriction allows the IBC mode to be implemented using local on-chip memory for hardware implementations.

### Joint Coding of Chroma Residuals

VVC supports the joint coding of chroma residual (JCCR) tool where the chroma residuals are coded jointly. The usage (activation) of the JCCR mode is indicated by a TU-level flag tu_joint_cbcr_residual_flag and the selected mode is implicitly indicated by the chroma CBFs. The flag tu_joint_cbcr_residual_flag is present if either or both chroma CBFs for a TU are equal to 1. In the PPS (Picture Parameter Set) and slice header, chroma QP offset values are signalled for the JCCR mode to differentiate from the usual chroma QP offset values signalled for regular chroma residual coding mode. These chroma QP offset values are used to derive the chroma QP values for some blocks coded using the JCCR mode. The JCCR mode has 3 sub-modes. When a corresponding JCCR sub-mode (sub-mode 2 in Table 1) is active in a TU, this chroma QP offset is added to the applied luma-derived chroma QP during quantization and decoding of that TU. For the other JCCR sub-modes (sub-modes 1 and 3 in Table 1), the chroma QPs are derived in the same way as for conventional Cb or Cr blocks. The reconstruction process of the chroma residuals (resCb and resCr) from the transmitted transform blocks is depicted in Table 1. When the JCCR mode is activated, one single joint chroma residual block (resJointC[x][y] in Table 1) is signalled, and residual block for Cb (resCb) and residual block for Cr (resCr) are derived considering information such as tu_cbf_cb, tu_cbf_cr, and CSign, which is a sign value specified in the slice header.

At the encoder side, the joint chroma components are derived as explained in the following. Depending on the mode (listed in the tables above), resJointC{1,2} are generated by the encoder as follows:

| | |
|---|---|
| - | If mode is equal to 2 (single residual with reconstruction Cb = C, Cr = CSign * C), the joint |
| | residual is determined according to |
| | resJointC[ x ][ y ] = ( resCb[ x ][ y ] + CSign * resCr[ x ][ y ] ) / 2 |
| - | Otherwise, if mode is equal to 1 (single residual with reconstruction Cb = C, Cr = (CSign |
| | * C) / 2), the joint residual is determined according to |
| | resJointC[ x ][ y ] = ( 4 * resCb[ x ][ y ] + 2 * CSign * resCr[ x ][ y ] ) / 5 |
| - | Otherwise (mode is equal to 3, i.e., single residual, reconstruction Cr = C, Cb = (CSign * |
| | C) / 2), the joint residual is determined according to |
| | resJointC[ x ][ y ] = ( 4 * resCr[ x ][ y ] + 2 * CSign * resCb[ x ][ y ] ) / 5 |

TABLE 1
Reconstruction of chroma residuals. The value CSign is
a sign value (+1 or −1), which is specified in the
slice header, resJointC[ ][ ] is the transmitted residual.

| tu_cbf_cb | tu_cbf_cr | reconstruction of Cb and Cr residuals | mode |
|---|---|---|---|
| 1 | 0 | resCb[ x ][ y ] = resJointC[ x ][ y ] | 1 |
| | | resCr[ x ][ y ] = ( CSign * | |
| | | resJointC[ x ][ y ] ) >> 1 | |
| 1 | 1 | resCb[ x ][ y ] = resJointC[ x ][ y ] | 2 |
| | | resCr[ x ][ y ] = CSign * | |
| | | resJointC[ x ][ y ] | |
| 0 | 1 | resCb[ x ][ y ] = ( CSign * | 3 |
| | | resJointC[ x ][ y ] ) >> 1 | |
| | | resCr[ x ][ y ] = resJointC[ x ][ y ] | |

The three joint chroma coding sub-modes described above are only supported in I slices. In P and B slices, only mode 2 is supported. Hence, in P and B slices, the syntax element tu_joint_cbcr_residual_flag is only present if both chroma cbfs are 1.

The JCCR mode can be combined with the chroma transform skip (TS) mode (more details of the TS mode can be found in Section 3.9.3 of JVET-T2002). To speed up the encoder decision, the JCCR transform selection depends on whether the independent coding of Cb and Cr components selects the DCT-2 or the TS as the best transform, and whether there are non-zero coefficients in independent chroma coding. Specifically, if one chroma component selects DCT-2 (or TS) and the other component is all zero, or both chroma components select DCT-2 (or TS), then only DCT-2 (or TS) will be considered in JCCR encoding. Otherwise, if one component selects DCT-2 and the other selects TS, then both, DCT-2 and TS, will be considered in JCCR encoding.

### CCLM (Cross Component Linear Model)

The main idea behind CCLM mode (sometimes abbreviated as LM mode) is as follows: chroma components of a block can be predicted from the collocated reconstructed luma samples by linear models whose parameters are derived from already reconstructed luma and chroma samples that are adjacent to the block.

In VVC, the CCLM mode makes use of inter-channel dependencies by predicting the chroma samples from reconstructed luma samples. This prediction is carried out using a linear model in the form

$$P ( i , j ) = a \cdot {rec}_{L}^{′} ( i , j ) + b . \qquad ( 1 )$$

Here, P(i,j) represents the predicted chroma samples in a CU and rec′_{L}(i,j) represents the reconstructed luma samples of the same CU which are down-sampled for the case of non-4:4:4 color format. The model parameters a and b are derived based on reconstructed neighbouring luma and chroma samples at both encoder and decoder side without explicit signalling.

Three CCLM modes, i.e., CCLM_LT, CCLM_L, and CCLM_T, are specified in VVC. These three modes differ with respect to the locations of the reference samples that are used for model parameter derivation. Samples only from the top boundary are involved in the CCLM_T mode and samples only from the left boundary are involved in the CCLM_L mode. In the CCLM_LT mode, samples from both the top boundary and the left boundary are used.

Overall, the prediction process of CCLM modes consists of three steps:
1) Down-sampling of the luma block and its neighbouring reconstructed samples to match the size of corresponding chroma block,
2) Model parameter derivation based on reconstructed neighbouring samples, and
3) Applying the model equation (1) to generate the chroma intra prediction samples.

Down-sampling of the Luma Component: To match the chroma sample locations for 4:2:0 or 4:2:2: colour format video sequences, two types of down-sampling filter can be applied to luma samples, both of which have a 2-to-1 down-sampling ratio in the horizontal and vertical directions. These two filters correspond to “type-0” and “type-2” 4:2:0 chroma format content, respectively and are given by

$${f}_{1} = ( \begin{matrix}0 & 1 & 0 \\ 1 & 4 & 1 \\ 0 & 1 & 0\end{matrix} ) , {f}_{2} = ( \begin{matrix}1 & 2 & 1 \\ 1 & 2 & 1\end{matrix} ) . \qquad ( 2 )$$

Based on the SPS-level flag information, the 2-dimensional 6-tap (i.e., f₂) or 5-tap (i.e., f₁) filter is applied to the luma samples within the current block as well as its neighbouring luma samples. The SPS-level refers to Sequence Parameter Set level. An exception happens if the top line of the current block is a CTU boundary. In this case, the one-dimensional filter [1, 2, 1]/4 is applied to the above neighbouring luma samples in order to avoid the usage of more than one luma line above the CTU boundary.

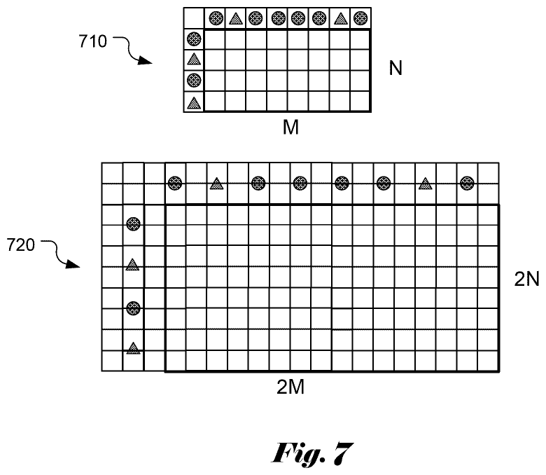

Model Parameter Derivation Process: The model parameters a and b from eqn. (1) are derived based on reconstructed neighbouring luma and chroma samples at both encoder and decoder sides to avoid the need for any signalling overhead. In the initially adopted version of the CCLM mode, the linear minimum mean square error (LMMSE) estimator was used for derivation of the parameters. In the final design, however, only four samples are involved to reduce the computational complexity. FIG. 7 shows the relative sample locations of M×N chroma block 710, the corresponding 2M×2N luma block 720 and their neighbouring samples (shown as filled circles and triangles) of “type-0” content.

In the example of FIG. 7, the four samples used in the CCLM_LT mode are shown, which are marked by triangular shape. They are located at the positions of M/4 and M·¾ at the top boundary and at the positions of N/4 and N·¾ at the left boundary. In CCLM_T and CCLM_L modes, the top and left boundary are extended to a size of (M+N) samples, and the four samples used for the model parameter derivation are located at the positions (M+N)/8, (M+N)·⅜, (M+N)·⅝, and (M+N)·⅞.

Once the four samples are selected, four comparison operations are used to determine the two smallest and the two largest luma sample values among them. Let Xₗ denote the average of the two largest luma sample values and let Xₛ denote the average of the two smallest luma sample values. Similarly, let Yₗ and Yₛ denote the averages of the corresponding chroma sample values. Then, the linear model parameters are obtained according to the following equation:

$$\begin{matrix}a = \frac{{Y}_{l} - {Y}_{s}}{{X}_{l} - {X}_{s}} \\ b = {Y}_{s} - a \cdot {X}_{s} .\end{matrix} \qquad ( 3 )$$

In this equation, the division operation to calculate the parameter a is implemented with a look-up table. To reduce the memory required for storing this table, the diff value, which is the difference between the maximum and minimum values, and the parameter a are expressed by an exponential notation. Here, the value of diff is approximated with a 4-bit significant part and an exponent. Consequently, the table for 1/diff only consists of 16 elements. This has the benefit of both reducing the complexity of the calculation and decreasing the memory size required for storing the tables.

### MMLM Overview

As indicated by the name, the original CCLM mode employs one linear model for predicting the chroma samples from the luma samples for the whole CU, while in MMLM (Multiple Model CCLM), there can be two models. In MMLM, neighbouring luma samples and neighbouring chroma samples of the current block are classified into two groups, each group is used as a training set to derive a linear model (i.e., particular α and β are derived for a particular group). Furthermore, the samples of the current luma block are also classified based on the same rule for the classification of neighbouring luma samples.
Threshold is calculated as the average value of the neighbouring reconstructed luma samples. A neighbouring sample with Rec′L[x,y]<=Threshold is classified into group 1; while a neighbouring sample with Rec′L[x,y]>Threshold is classified into group 2.
Correspondingly, a prediction for chroma is obtained using linear models:

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix}$$

### Chroma DM (Derived Mode) Mode

For Chroma DM mode, the intra prediction mode of the corresponding (collocated) luma block covering the centre position of the current chroma block is directly inherited.

### Decoder Side Intra Mode Derivation (DIMD)

When DIMD is applied, two intra modes are derived from the reconstructed neighbour samples, and those two predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, centered on the pixels of the middle line of the template. At each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 4 )$$

which can be converted into one of 65 angular intra prediction modes. Once the intra prediction mode index of current window is derived as idx, the amplitude of its entry in the HoG[idx] is updated by addition of:

$$ampl = \vert {G}_{x} \vert + \vert {G}_{y} \vert \qquad ( 5 )$$

FIGS. 8A-C show an example of HoG, calculated after applying the above operations on all pixel positions in the template. FIG. 8A illustrates an example of selected template 820 for a current block 810. Template 820 comprises T lines above the current block and T columns to the left of the current block. For intra prediction of the current block, the area 830 at the above and left of the current block corresponds to a reconstructed area and the area 840 below and at the right of the block corresponds to an unavailable area. FIG. 8B illustrates an example for T=3 and the HoGs are calculated for pixels 860 in the middle line and pixels 862 in the middle column. For example, for pixel 852, a 3×3 window 850 is used. FIG. 8C illustrates an example of the amplitudes (ampl) calculated based on equation (16) for the angular intra prediction modes as determined from equation (4).

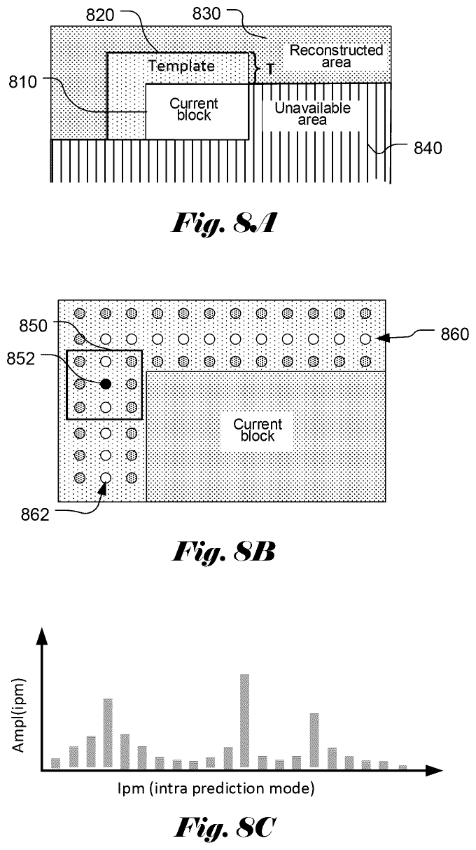

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (~⅓). The remaining weight of 43/64 {grave over (()}~⅔) is then shared between the two HoG IPMs, proportionally to the amplitude of their HoG bars. FIG. 9 illustrates an example of the blending process. As shown in FIG. 9, two intra modes (M1 912 and M2 914) are selected according to the indices with two tallest bars of histogram bars 910. The three predictors (940, 942 and 944) are used to form the blended prediction. The three predictors correspond to applying the M1, M2 and planar intra modes (920, 922 and 924 respectively) to the reference pixels 930 to form the respective predictors. The three predictors are weighted by respective weighting factors (ω₁, ω₂ and ω₃ 950. The weighted predictors are summed using adder 952 to generated the blended predictor 960.

Besides, the two implicitly derived intra modes are included into the MPM list so that the DIMD process is performed before the MPM list is constructed. The primary derived intra mode of a DIMD block is stored with a block and is used for MPM list construction of the neighbouring blocks.

### Template-Based Intra Mode Derivation (TIMD)

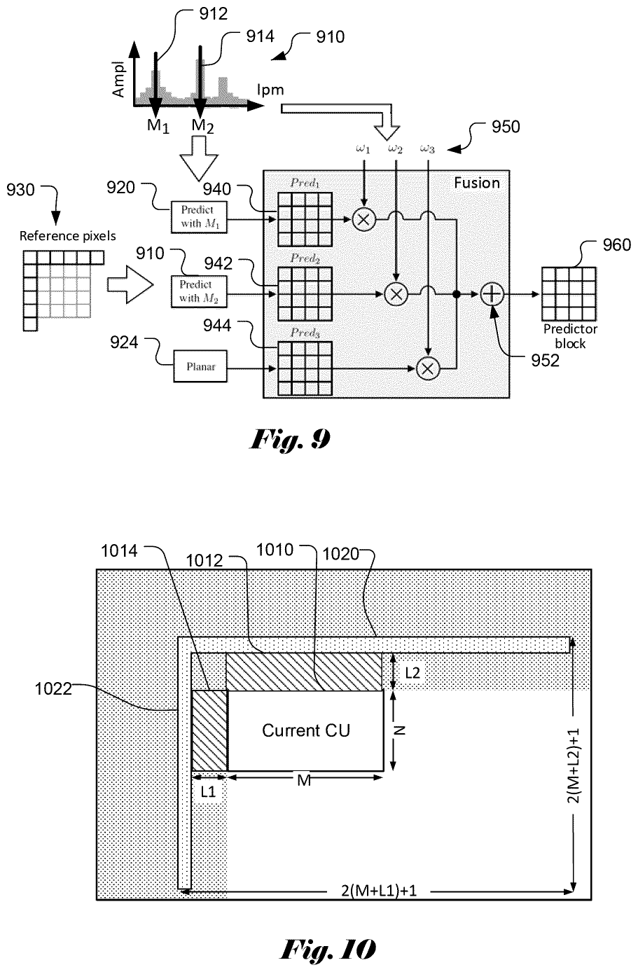

Template-based intra mode derivation (TIMD) mode implicitly derives the intra prediction mode of a CU using a neighbouring template at both the encoder and decoder, instead of signalling the intra prediction mode to the decoder. As shown in FIG. 10, the prediction samples of the template (1012 and 1014) for the current block 1010 are generated using the reference samples (1020 and 1022) of the template for each candidate mode. A cost is calculated as the SATD (Sum of Absolute Transformed Differences) between the prediction samples and the reconstruction samples of the template. The intra prediction mode with the minimum cost is selected as the DIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used. Weights of the modes are computed from their SATD costs as follows:

$$\begin{matrix}weight 1 = costMode 2 / ( costMode 1 + costMode 2 ) \\ weight 2 = 1 - weight 1.\end{matrix}$$

### Inter Prediction Overview

According to JVET-T2002 Section 3.4. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CTIP)

The following description provides the details of those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set (SPS) header and the maximum allowed size of merge list is 6. For each CU coded in the merge mode, an index of best merge candidate is encoded using truncated unary binarization (TU). The first bin of the merge index is coded with context and bypass coding is used for remaining bins.

The derivation process of each category of the merge candidates is provided in this session. As done in HEVC, VVC also supports parallel derivation of the merge candidate lists (or called as merging candidate lists) for all CUs within a certain size of area.

### Spatial Candidate Derivation

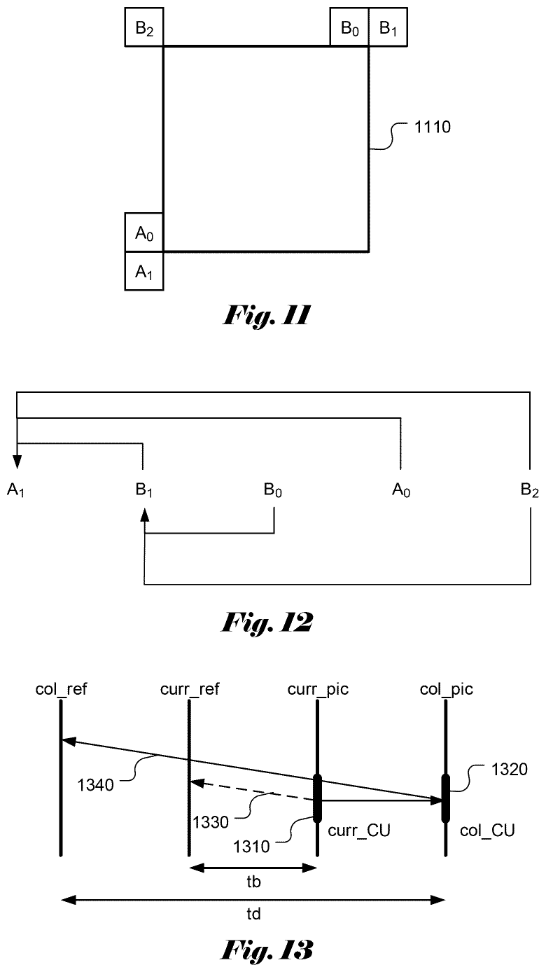

The derivation of spatial merge candidates in VVC is the same as that in HEVC except that the positions of first two merge candidates are swapped. A maximum of four merge candidates (B₀, A₀, B₁ and A₁) for current CU 1110 are selected among candidates located in the positions depicted in FIG. 11. The order of derivation is B₀, A₀, B₁, A₁ and B₂. Position B₂ is considered only when one or more neighbouring CU of positions B₀, A₀, B₁, A₁ are not available (e.g. belonging to another slice or tile) or is intra coded. After candidate at position A₁ is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 12 are considered and a candidate is only added to the list if the corresponding candidate used for redundancy check does not have the same motion information.

### Temporal Candidates Derivation

In this step, only one candidate is added to the list. Particularly, in the derivation of this temporal merge candidate for a current CU 1310, a scaled motion vector is derived based on the co-located CU 1320 belonging to the collocated reference picture as shown in FIG. 13. The reference picture list and the reference index to be used for the derivation of the co-located CU is explicitly signalled in the slice header. The scaled motion vector 1330 for the temporal merge candidate is obtained as illustrated by the dotted line in FIG. 13, which is scaled from the motion vector 1340 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

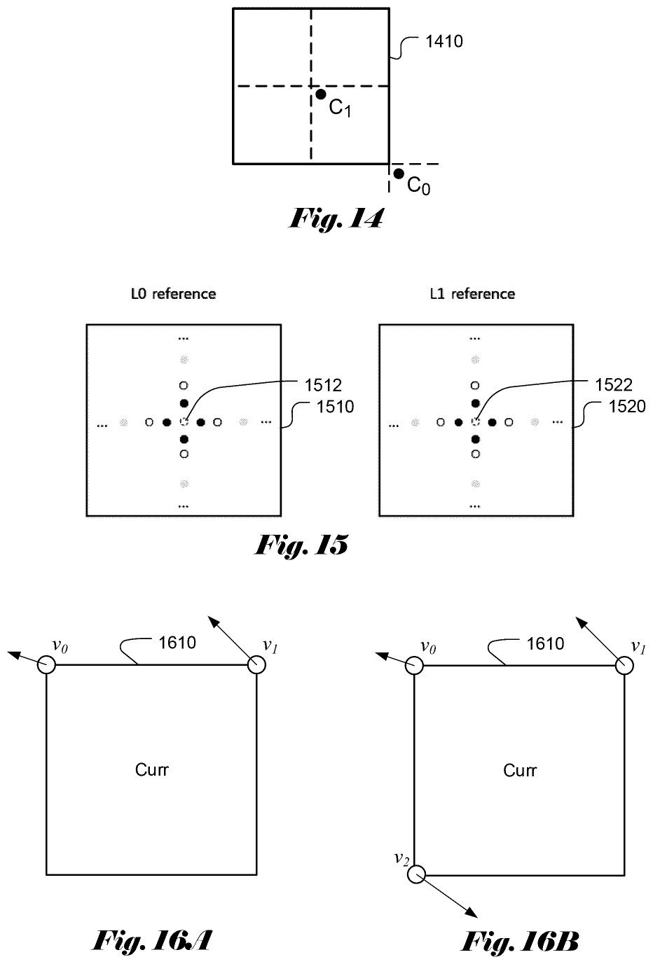

The position for the temporal candidate is selected between candidates C₀ and C₁, as depicted in FIG. 14. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to the merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized where redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy, check operations, the following simplifications are introduced:
1. The last two entries in the table are checked for redundancy with respect to A₁ and B₁ spatial candidates, respectively.
2. Once the total number of available merge candidates reaches the maximally allowed merge candidates minus 1, the merge candidate list construction process from HMVP is terminated.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; and if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### Merge Estimation Region

Merge estimation region (MER) allows independent derivation of merge candidate list for the CUs in the same merge estimation region (MER). A candidate block that is within the same MER as the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel), and where (xCb, yCb) is the top-left luma sample position of the current CU in the picture and (cbWidth, cbHeight) is the CU size. The MER size is selected at the encoder side and signalled as log 2_parallel_merge_level_minus2 in the Sequence Parameter Set (SPS).

Merge Mode with MVD (MMVD)

In addition to the merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected (referred as a base merge candidate in this disclosure), it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicates the pre-defined offset from the starting points (1512 and 1522) for a L0 reference block 1510 and L1 reference block 1520. As shown in FIG. 15, an offset is added to either horizontal component or vertical component of the starting MV, where small circles in different styles correspond to different offsets from the centre. The relation of distance index and pre-defined offset is specified in Table 2.

TABLE 2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent the four directions as shown in Table 2. It is noted that the meaning of MVD sign could be variant according to the information of starting MVs. When the starting MVs are an un-prediction MV or bi-prediction MVs with both lists pointing to the same side of the current picture (i.e. POCs of two references both larger than the POC of the current picture, or both smaller than the POC of the current picture), the sign in Table 3 specifies the sign of the MV offset added to the starting MV. When the starting MVs are bi-prediction MVs with the two MVs pointing to the different sides of the current picture (i.e. the POC of one reference larger than the POC of the current picture, and the POC of the other reference smaller than the POC of the current picture), and the difference of POC in list 0 is greater than the one in list 1, the sign in Table 3 specifies the sign of MV offset added to the list0 MV component of the starting MV and the sign for the list1 MV has an opposite value. Otherwise, if the difference of POC in list 1 is greater than list 0, the sign in Table 3 specifies the sign of the MV offset added to the list1 MV component of starting MV and the sign for the list0 MV has an opposite value.

The MVD is scaled according to the difference of POCs in each direction. If the differences of POCs in both lists are the same, no scaling is needed. Otherwise, if the difference of POC in list 0 is larger than the one in list 1, the MVD for list 1 is scaled, by defining the POC difference of L0 as td and POC difference of L1 as tb, described in FIG. 13. If the POC difference of L1 is greater than L0, the MVD for list 0 is scaled in the same way. If the starting MV is uni-predicted, the MVD is added to the available MV.

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### Affine Motion Compensated Prediction

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIG. 16A-B, the affine motion field of the block 1610 is described by motion information of two control point (4-parameter) in FIG. 16A or three control point motion vectors (6-parameter) in FIG. 16B.

For 4-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 y} - m {v}_{0 x}}{W} y + m {v}_{0 y}\end{matrix} \qquad ( 6 )$$

For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 7 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

In order to simplify the motion compensation prediction, block based affine transform prediction is applied. To derive motion vector of each 4×4 luma subblock, the motion vector of the centre sample of each subblock, as shown in FIG. 17, is calculated according to above equations, and rounded to 1/16 fraction accuracy. Then, the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As is for translational-motion inter prediction, there are also two affine motion inter prediction modes: affine merge mode and affine AMVP mode.

### Affine Merge Prediction

AF_MERGE mode can be applied for CUs with both width and height larger than or equal to 8. In this mode, the CPMVs (Control Point MVs) of the current CU is generated based on the motion information of the spatial neighbouring CUs. There can be up to five CPMVP (CPMV Prediction) candidates and an index is signalled to indicate the one to be used for the current CU. The following three types of CPVM candidate are used to form the affine merge candidate list:
Inherited affine merge candidates that are extrapolated from the CPMVs of the neighbour CUs
Constructed affine merge candidates CPMVPs that are derived using the translational MVs of the neighbour CUs
Zero MVs

In VVC, there are two inherited affine candidates at most, which are derived from the affine motion model of the neighbouring blocks, one from left neighbouring CUs and one from above neighbouring CUs. The candidate blocks are the same as those shown in FIG. 11. For the left predictor, the scan order is A₀->A₁, and for the above predictor, the scan order is B₀->B₁->B₂. Only the first inherited candidate from each side is selected. No pruning check is performed between two inherited candidates. When a neighbouring affine CU is identified, its control point motion vectors are used to derived the CPMVP candidate in the affine merge list of the current CU. As shown in FIG. 18, if the neighbouring left bottom block A of the current block 1810 is coded in affine mode, the motion vectors v₂, v₃ and v₄ of the top left corner, above right corner and left bottom corner of the CU 1820 containing block A are attained. When block A is coded with 4-parameter affine model, the two CPMVs of the current CU (i.e., v₀ and v₁) are calculated according to v₂, and v₃. In case that block A is coded with 6-parameter affine model, the three CPMVs of the current CU are calculated according to v₂, v₃ and v₄.

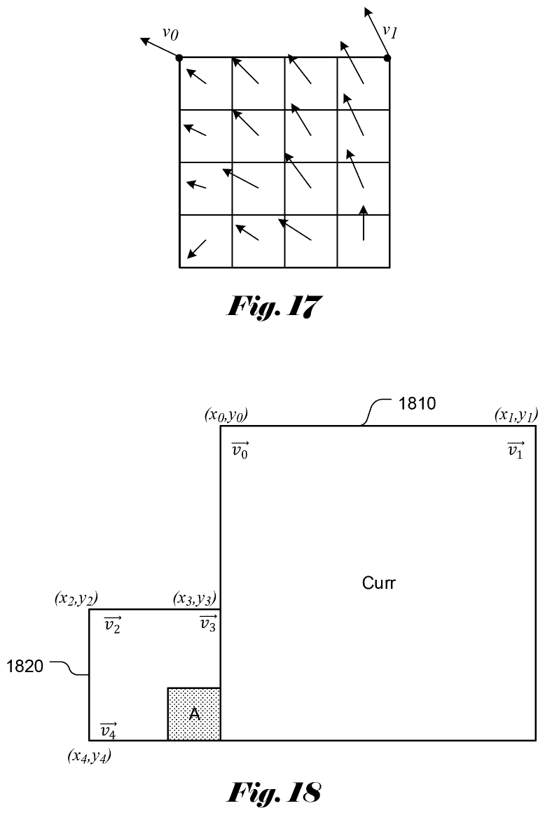

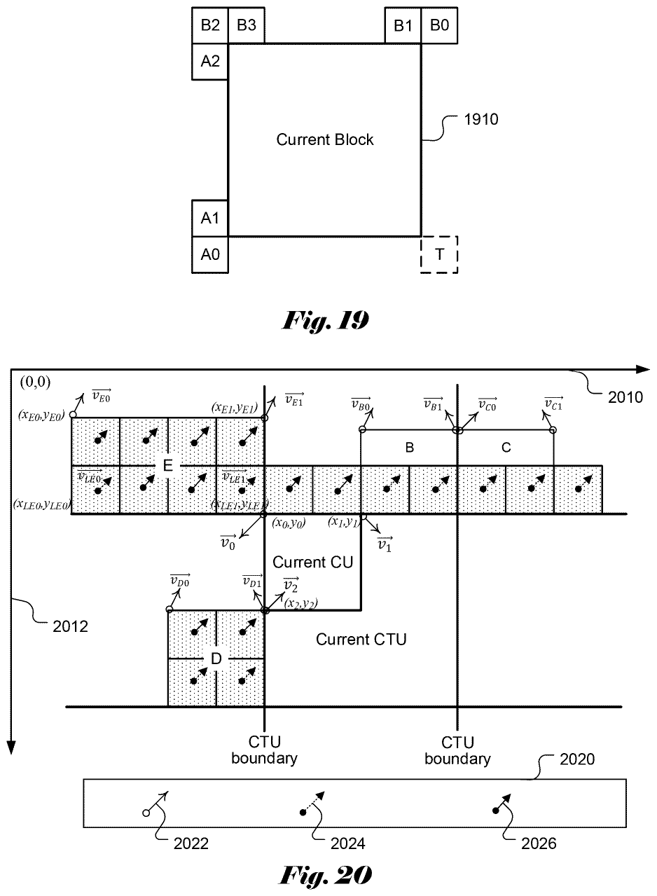

Constructed affine candidate means the candidate is constructed by combining the neighbouring translational motion information of each control point. The motion information for the control points is derived from the specified spatial neighbours and temporal neighbour for a current block 1910 as shown in FIG. 19. CPMVₖ (k=1, 2, 3, 4) represents the k-th control point. For CPMV₁, the B₂->B₃->A₂ blocks are checked and the MV of the first available block is used. For CPMV₂, the B₁->B₀ blocks are checked and for CPMV₃, the A₁->A₀ blocks are checked. For TMVP is used as CPMV₄ if it's available.

After MVs of four control points are attained, affine merge candidates are constructed based on the motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### Affine AMVP Prediction

Affine AMVP mode can be applied for CUs with both width and height larger than or equal to 16. An affine flag in the CU level is signalled in the bitstream to indicate whether affine AMVP mode is used and then another flag is signalled to indicate whether 4-parameter affine or 6-parameter affine is used. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighbouring CUs
Zero MVs

The checking order of inherited affine AMVP candidates is the same as the checking order of inherited affine merge candidates. The only difference is that, for AVMP candidate, only the affine CU that has the same reference picture as current block is considered. No pruning process is applied when inserting an inherited affine motion predictor into the candidate list.

Constructed AMVP candidate is derived from the specified spatial neighbours of current CU 1910 shown in FIG. 19. The same checking order is used as that in the affine merge candidate construction. In addition, the reference picture index of the neighbouring block is also checked. In the checking order, the first block that is inter coded and has the same reference picture as in current CUs is used. When the current CU is coded with the 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, the constructed AMVP candidate is set as unavailable.

If the number of affine AMVP list candidates is still less than 2 after valid inherited affine AMVP candidates and constructed AMVP candidate are inserted, mv₀, mv₁ and mv₂ will be added as the translational MVs in order to predict all control point MVs of the current CU, when available. Finally, zero MVs are used to fill the affine AMVP list if it is still not full.

### Affine Motion Information Storage

In VVC, the CPMVs of affine CUs are stored in a separate buffer. The stored CPMVs are only used to generate the inherited CPMVPs in the affine merge mode and affine AMVP mode for the lately coded CUs. The subblock MVs derived from CPMVs are used for motion compensation, MV derivation of merge/AMVP list of translational MVs and de-blocking.

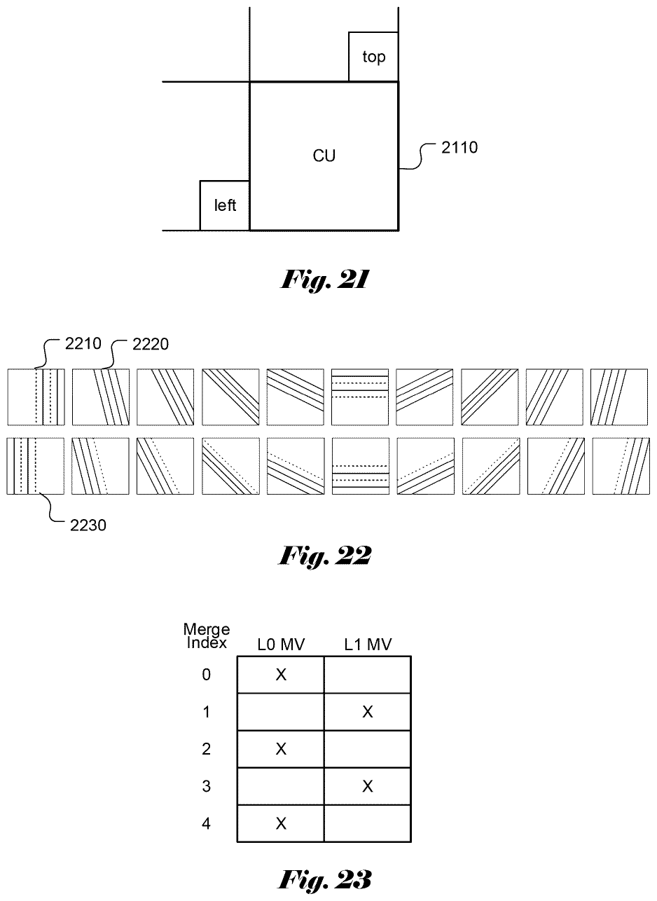

To avoid the picture line buffer for the additional CPMVs, affine motion data inheritance from the CUs of the above CTU is treated differently for the inheritance from the normal neighbouring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in a local buffer. If the candidate CU is 6-parameter affine coded, the affine model is degraded to 4-parameter model. As shown in FIG. 20, along the top CTU boundary, the bottom-left and bottom right subblock motion vectors of a CU are used for affine inheritance of the CUs in bottom CTUs. In FIG. 20, line 2010 and line 2012 indicate the x and y coordinates of the picture with the origin (0,0) at the upper left corner. Legend 2020 shows the meaning of various motion vectors, where arrow 2022 represents the CPMVs for affine inheritance in the local buff, arrow 2024 represents sub-block vectors for MC/merge/skip/AMVP/deblocking/TMVPs in the local buffer and for affine inheritance in the line buffer, and arrow 2026 represents sub-block vectors for MC/merge/skip/AMVP/deblocking/TMVPs.

### Adaptive Motion Vector Resolution (AMVR)

In HEVC, motion vector differences (MVDs) (between the motion vector and predicted motion vector of a CU) are signalled in units of quarter-luma-sample when use_integer_mv_flag is equal to 0 in the slice header. In VVC, a CU-level adaptive motion vector resolution (AMVR) scheme is introduced. AMVR allows MVD of the CU to be coded in different precisions. Dependent on the mode (normal AMVP mode or affine AVMP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.

The CU-level MVD resolution indication is conditionally signalled if the current CU has at least one non-zero MVD component. If all MVD components (that is, both horizontal and vertical MVDs for reference list L0 and reference list L1) are zero, quarter-luma-sample MVD resolution is inferred.

For a CU that has at least one non-zero MVD component, a first flag is signalled to indicate whether quarter-luma-sample MVD precision is used for the CU. If the first flag is 0, no further signalling is needed and quarter-luma-sample MVD precision is used for the current CU. Otherwise, a second flag is signalled to indicate half-luma-sample or other MVD precisions (integer or four-luma sample) is used for a normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for the normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (that is, a negative motion vector predictor is rounded toward positive infinity and a positive motion vector predictor is rounded toward negative infinity).

The encoder determines the motion vector resolution for the current CU using RD check. To avoid always performing the CU-level RD check four times for each MVD resolution, the RD check of MVD precisions other than quarter-luma-sample is only invoked conditionally in VTM11. For the normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for the quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For the affine AMVP mode, if the affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore, affine parameters obtained in quarter-luma-sample MV precision affine inter mode are used as starting search point in 1/16 luma-sample and quarter-luma-sample MV precision affine inter modes.

Bi-Prediction with CU-Level Weight (BCW)

In HEVC, the bi-prediction signal, P_{bi-pred} is generated by averaging two prediction signals, P₀ and P₁ obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) ≫ 3 \qquad ( 8 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used. At the encoder, fast search algorithms are applied to find the weight index without significantly increasing the encoder complexity. These algorithms are summarized as follows. The details are disclosed in the VTM software and document JVET-L0646 (Yu-Chi Su, et. al., “CE4-related: Generalized bi-prediction improvements combined from JVET-L0197 and JVET-L0296”, Joint Video Experts Team (JVET) of ITU-T SG 16 WP 3 and ISO/IEC JTC 1/SC 29, 12th Meeting: Macao, CN, 3-12 Oct. 2018, Document: JVET-L0646).
When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP is also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and weight w is inferred to be 4 (i.e. equal weight is applied). For a merge CU, the weight index is inferred from neighbouring blocks based on the merge candidate index. This can be applied to both the normal merge mode and inherited affine merge mode. For the constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, (i.e., w=4 for equal weight). Equal weight implies the default value for the BCW index.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks (as shown in FIG. 21) of current CU 2110 as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{inter} + w t * {P}_{intra} + 2 ) ≫ 2 \qquad ( 9 )$$

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-M2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2^{m}×2ⁿ with m,n∈{3 . . . 6} excluding 8×64 and 64×8. The GPM mode can be applied to skip or merge CUs having a size within the above limit and having at least two regular merge modes.

When this mode is used, a CU is split into two parts by a geometrically located straight line in certain angles. In VVC, there are a total of 20 angles and 4 offset distances used for GPM, which has been reduced from 24 angles in an earlier draft. The location of the splitting line is mathematically derived from the angle and offset parameters of a specific partition. In VVC, there are a total of 64 partitions as shown in FIG. 22, where the partitions are grouped according to their angles and dashed lines indicate redundant partitions. Each part of a geometric partition in the CU is inter-predicted using its own motion; only uni-prediction is allowed for each partition, that is, each part has one motion vector and one reference index. In FIG. 22, each line corresponds to the boundary of one partition. The partitions are grouped according to its angle. For example, partition group 2210 consists of three vertical GPM partitions (i.e., 90°). Partition group 2220 consists of four slant GPM partitions with a small angle from the vertical direction. Also, partition group 2230 consists of three vertical GPM partitions (i.e., 270°) similar to those of group 2210, but with an opposite direction. The uni-prediction motion constraint is applied to ensure that only two motion compensated prediction are needed for each CU, same as the conventional bi-prediction. The uni-prediction motion for each partition is derived using the process described later.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) and specifies syntax binarization for GPM merge indices. After predicting each of part of the geometric partition, the sample values along the geometric partition edge are adjusted using a blending processing with adaptive weights using the process described later. This is the prediction signal for the whole CU, and transform and quantization process will be applied to the whole CU as in other prediction modes. Finally, the motion field of a CU predicted using the geometric partition modes is stored using the process described later.

### Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate (X=0 or 1, i.e., LX=L0 or L1), with X equal to the parity of n, is used as the n-th uni-prediction motion vector for geometric partitioning mode. These motion vectors are marked with “x” in FIG. 23. In case a corresponding LX motion vector of the n-the extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

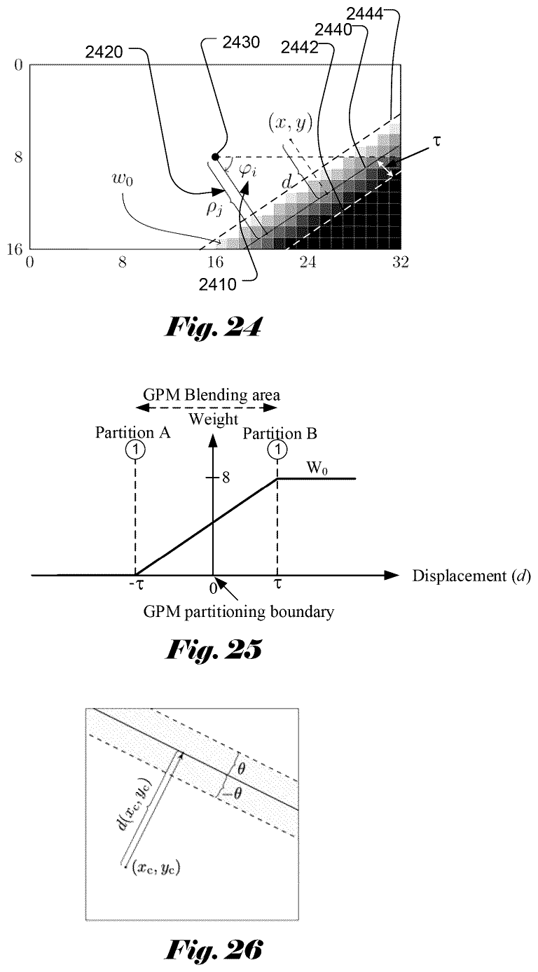

The two integer blending matrices (W₀ and W₁) are utilized for the GPM blending process. The weights in the GPM blending matrices contain the value range of [0, 8] and are derived based on the displacement from a sample position to the GPM partition boundary 2440 as shown in FIG. 24.

Specifically, the weights are given by a discrete ramp function with the displacement and two thresholds as shown in FIG. 25, where the two end points (i.e., −τ and τ) of the ramp correspond to lines 2442 and 2444 in FIG. 24.

Here, the threshold T defines the width of the GPM blending area and is selected as the fixed value in VVC. In other words, as JVET-Z0137 (Han Gao, et. al., “Non-EE2: Adaptive Blending for GPM”, Joint Video Experts Team (JVET) of ITU-T SG 16 WP 3 and ISO/IEC JTC 1/SC 29, 26th Meeting, by teleconference, 20-29 Apr. 2022, JVET-Z0137), the blending strength or blending area width θ is fixed for all different contents.

The weighing values in the blending mask can be given by a ramp function

$${ω}_{{x}_{c} , {y}_{c}} = \{ \begin{matrix}0 & d ( {x}_{c} , {y}_{c} ) \leq - θ \\ \frac{8}{2 θ} ( d ( {x}_{c} , {y}_{c} ) + θ ) & - θ < d ( {x}_{c} , {y}_{c} ) < θ \\ 8 & d ( {x}_{c} , {y}_{c} ) \geq θ ,\end{matrix} \qquad ( 10 )$$

With a fixed θ=2 pel in the current ECM (VVC) design, this ramp function can be quantized as:

$${ω}_{m , n} = Clip 3 ( 0 , 8 , d ( m , n ) + 32 + 4 ) ≫ 3 ) \qquad ( 11 )$$

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 12 )$$

$${ρ}_{j} = {ρ}_{x , j} cos ( {φ}_{i} ) + {ρ}_{y , j} sin ( {φ}_{i} ) \qquad ( 13 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 14 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 15 )$$

where i,j are the indices for angle and offset of a geometric partition, which depend on the signalled geometric partition index. The sign of ρ_{x,j} and ρ_{y,j} depend on angle index i.

FIG. 26 illustrates an example of GPM blending according to ECM 4.0 (Muhammed Coban, et. al., “Algorithm description of Enhanced Compression Model 4 (ECM 4)”, Joint Video Experts Team (JVET) of ITU-T SG 16 WP 3 and ISO/IEC JTC 1/SC 29, 26th Meeting, by teleconference, 20-29 Apr. 2022, JVET-Y2025). In FIG. 26, the size of the blending region on each side of the partition boundary is indicated by θ. The weights for each part of a geometric partition are derived as following:

$$wIdxL ( x , y ) = partIdx ? 32 + d ( x , y ) : 32 - d ( x , y ) \qquad ( 16 )$$

$${w}_{0} ( x , y ) = \frac{Clip 3 ( 0 , 8 , ( wIdxL ( x , y ) + 4 ) ≫ 3 )}{8} \qquad ( 17 )$$

$${w}_{1} ( x , y ) - 1 - {w}_{0} ( x , y ) \qquad ( 18 )$$

The partIdx depends on the angle index i. One example of weigh w₀ is illustrated in FIG. 24, where the angle φᵢ 2410 and offset ρᵢ 2420 are indicated for GPM index i and point 2430 corresponds to the center of the block. Line 2440 corresponds to the GPM partitioning boundary

### Motion Field Storage for Geometric Partitioning Mode

Mv1 from the first part of the geometric partition, Mv2 from the second part of the geometric partition and a combined MV of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 19 )$$

where motionIdx is equal to d(4x+2, 4y+2), which is recalculated from equation (7). The partIdx depends on the angle index i.

If sType is equal to 0 or 1, Mv0 or Mv1 are stored in the corresponding motion field, otherwise if sType is equal to 2, a combined MV from Mv0 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### Multi-Hypothesis Prediction (MHP)

In the multi-hypothesis inter prediction mode (JVET-M0425), one or more additional motion-compensated prediction signals are signalled, in addition to the conventional bi-prediction signal. The resulting overall prediction signal is obtained by sample-wise weighted superposition. With the bi-prediction signal P_{bi} and the first additional inter prediction signal/hypothesis h₃, the resulting prediction signal p₃ is obtained as follows:

$${p}_{3} = ( 1 - α ) {p}_{b i} + α {h}_{3} \qquad ( 20 )$$

The weighting factor α is specified by the new syntax element add_hyp_weight_idx, according to the following mapping (Table 4):

TABLE 4
Mapping α to add_hyp_weight_idx

| add_hyp_weight_idx | α |
|---|---|
| 0 | 1/4 |
| 1 | −1/8 |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1} \qquad ( 21 )$$

The resulting overall prediction signal is obtained as the last pₙ (i.e., the pₙ having the largest index n). For example, up to two additional prediction signals can be used (i.e., n is limited to 2).

The motion parameters of each additional prediction hypothesis can be signalled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode. Details of MHP for VVC can be found in JVET-W2025 (Muhammed Coban, et. al., “Algorithm description of Enhanced Compression Model 2 (ECM 2)”, Joint Video Experts Team (JVET) of ITU-T SG 16 WP 3 and ISO/IEC JTC 1/SC 29, 23rd Meeting, by teleconference, 7-16 Jul. 2021, Document: JVET-W2025).

### GPM Extension

Several variations of GPM mode (JVET-W0097 (Zhipin Deng, et. al., “AEE2-related: Combination of EE2-3.3, EE2-3.4 and EE2-3.5”, Joint Video Experts Team (JVET) of ITU-T SG 16 WP 3 and ISO/IEC JTC 1/SC 29, 23rd Meeting, by teleconference, 7-16 Jul. 2021, Document: JVET-W0097) and JVET-Y0065 (Yoshitaka Kidani, et. al., “EE2-3.1: GPM with inter and intra prediction (JVET-X0166)”, Joint Video Experts Team (JVET) of ITU-T SG 16 WP 3 and ISO/IEC JTC 1/SC 29, 25th Meeting, by teleconference, 12-21 Jan. 2022, Document: JVET-Y0065)) have been proposed to improve the coding efficiency of the GPM mode in the VVC. The methods were included in the exploration experiment (EE2) for further evaluations, the main technical aspects of which are described as follows: EE2-3.3 on GPM with MMVD (GPM-MMVD): 1) additional MVDs are added to the existing GPM merge candidates; 2) the MVDs are signalled in the same manner as the MMVD in the VVC, i.e., one distance index plus one direction index; 3) two flags are signalled to separately control whether the MMVD is applied to each GPM partition or not.

EE2-3.4-3.5 on GPM with template matching (GPM-TM): 1) template matching is extended to the GPM mode by refining the GPM MVs based on the left and above neighbouring samples of the current CU; 2) the template samples are selected dependent on the GPM split direction; 3) one single flag is signalled to jointly control whether the template matching is applied to the MVs of two GPM partitions or not.

JVET-W0097 proposes a combination of EE2-3.3, EE2-3.4 and EE2-3.5 to further improve the coding efficiency of the GPM mode. Specifically, in the proposed combination, the existing designs in EE2-3.3, EE2-3.4 and EE2-3.5 are kept unchanged while the following modifications are further applied for the harmonization of the two coding tools:
1) The GPM-MMVD and GPM-TM are exclusively enabled to one GPM CU. This is done by firstly signalling the GPM-MMVD syntax. When both two GPM-MMVD control flags are equal to false (i.e., the GPM-MMVD are disabled for two GPM partitions), the GPM-TM flag is signalled to indicate whether the template matching is applied to the two GPM partitions. Otherwise (at least one GPM-MMVD flag is equal to true), the value of the GPM-TM flag is inferred to be false.
2) The GPM merge candidate list generation methods in EE2-3.3 and EE2-3.4-3.5 are directly combined in a manner that the MV pruning scheme in EE2-3.4-3.5 (where the MV pruning threshold is adapted based on the current CU size) is applied to replace the default MV pruning scheme applied in EE2-3.3; additionally, as in EE2-3.4-3.5, multiple zero MVs are added until the GPM candidate list is fully filled.

In JVET-Y0065, in GPM with inter and intra prediction (or named GPM intra), the final prediction samples are generated by weighting inter predicted samples and intra predicted samples for each GPM-separated region. The inter predicted samples are derived by the same scheme as the GPM in the current ECM whereas the intra predicted samples are derived by an intra prediction mode (IPM) candidate list and an index signalled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIGS. 27A-C, respectively. Furthermore, GPM with intra and intra prediction as shown FIG. 27D is restricted in the proposed method to reduce the signalling overhead for IPMs and avoid an increase in the size of the intra prediction circuit on the hardware decoder. In addition, a direct motion vector and IPM storage on the GPM-blending area is introduced to further improve the coding performance.

### Spatial GPM

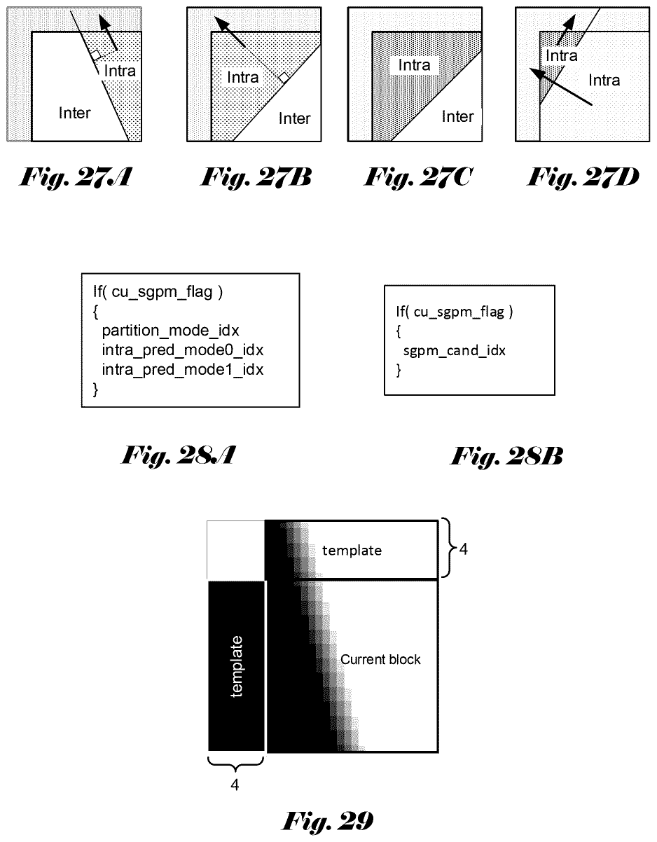

Similar to inter GPM, Spatial GPM (SGPM) consists of one partition mode and two associated intra prediction modes. If these modes are directly signalled in the bit-stream, as shown in FIG. 28A, it would yield significant overhead bits. To express the necessary partition and prediction information more efficiently in the bit-stream, a candidate list is employed and only the candidate index is signalled in the bit-stream. Each candidate in the list can derive a combination of one partition mode and two intra prediction modes, as shown in FIG. 28B.

A template is used to generate this candidate list. The shape of the template is shown in FIG. 29. For each possible combination of one partition mode and two intra prediction modes, a prediction is generated for the template with the partitioning weight extended to the template, as shown in FIG. 29. These combinations are ranked in ascending order of their SATD between the prediction and reconstruction of the template. The length of the candidate list is set equal to 16, and these candidates are regarded as the most probable SGPM combinations of the current block. Both encoder and decoder construct the same candidate list based upon the template.

To reduce the complexity in building the candidate list, both the number of possible partition modes and the number of possible intra prediction modes are pruned. In the following test, 26 out of 64 partition modes are used, and only the MPMs out of 67 intra prediction modes are used.

### Overlapped Motion Compensation (OBMC)

When OBMC is applied, top and left boundary pixels of a CU are refined using neighbouring block's motion information with a weighted prediction as described in JVET-L0101 (Zhi-Yi Lin, et al. “CE10.2.1: OBMC”, Joint Video Experts Team (JVET) of ITU-T SG 16 WP 3 and ISO/TEC JTC 1/SC 29, 12th Meeting: Macao, CN, 3-12 Oct. 2018, Document: JVET-L0101).

Conditions of not applying OBMC are as follows:
When OBMC is disabled at SPS level
When the current block has intra mode or IBC mode
When the current block applies LIC
When the current luma block area is smaller than or equal to 32

A subblock-boundary OBMC is performed by applying the same blending to the top, left, bottom, and right subblock boundary pixels using neighbouring subblocks' motion information. It is enabled for the subblock based coding tools:
Affine AMVP modes;
Affine merge modes and subblock-based temporal motion vector prediction (SbTMVP);
Subblock-based bilateral matching.

In order to improve the coding efficiency for cross-colour prediction, various techniques are disclosed as follows.

### Reconstructed Neighbouring Sample Pre-processing

When deriving model parameters, reconstructed neighbouring samples for the first component and second component are used. Take the CCLM described in the overview section as an example. The first component is luma and the second component is cb or cr. To improve the model performance, the reconstructed neighbouring samples are pre-processed before becoming the inputs for deriving model parameters.

FIG. 30 illustrates an example of the reconstructed neighbouring samples pre-processed before being becoming the inputs for deriving model parameters, where a neighbouring region 3010 of a luma block 3012 and a neighbouring region 3020 of a chroma (cb or cr) block 3012 are pre-processed before being provided to the model parameter derivation block 3030.

In one embodiment, the reconstructed neighbouring samples of the first component are pre-processed.

In one embodiment, the reconstructed neighbouring samples of the second component are pre-processed.

In another embodiment, the reconstructed neighbouring samples of only one of the first and the second component are pre-processed.

In one embodiment, the pre-processing methods can be (but are not limited to) any one or any combination of following processes: 3×3 or 5×5 filtering, biasing, clipping, filtering or clipping like ALF or CCALF, SAO-like filtering, filter sets (e.g. ALF sets)

In another embodiment, the first component is any one of luma, cb, and cr. For example, when the first component is luma, the second component is cb or cr. For another example, when the first component is cb, the second component is luma or cr. For another example, when the first component is cr, the second component is luma or cb. For another example, when the first component is luma, the second component is based on weighted combination of cb and cr.

In one embodiment, the pre-processing method of one component (e.g. cr) depends on another component (e.g. cb). For example, the selection of pre-processing method for cb is derived according to signalling/bitstream and cr follows cb's selection. For another example, it is assumed that high correlation exists between cb and cr, so the selection of pre-processing method for cr is shown as follows:
The cb reconstruction (without pre-processing) plus cb residuals are treated as golden (i.e., a target to guide the process)
Choosing cr's pre-processing method according to cb's pre-processed reconstruction and golden
For example, if the cb's pre-processed reconstruction is very similar to golden, use cb's pre-processing method as cr's pre-processing method.

In another embodiment, the pre-processing method is applied right after reconstructing neighbouring samples of the first and/or second component.

In another embodiment, the pre-processing method is applied to the reconstructed neighbouring samples before generating the model parameters for the current block.

### Prediction Sample Post-processing

After applying CCLM to the current block, the prediction of the current block is generated and can be further adjusted with post-processing methods. The post-processing methods can be (but are not limited to) any one or any combination of following processes: 3×3 or 5×5 filtering, biasing, clipping, filtering or clipping like ALF or CCALF, SAO-like filtering, filter sets (e.g. ALF sets).

In one embodiment, the current block refers to luma, cb and/or cr. For example, when LM (e.g. proposed inverse LM described in a later section of this disclosure) is used to generate luma prediction, the post-processing is applied to luma. For another example, when CCLM is used to generate chroma prediction, the post-processing is applied to chroma.

In another embodiment, when the block size (width and/or height) is larger than a threshold, the post-processing is applied.

In another embodiment, the post-processing method of one component (e.g. cr) depends on another component (e.g. cb). For example, the selection of post-processing method for cb is derived according to signalling/bitstream and cr follows cb's selection. For another example, it is assumed that high correlation exists between cb and cr, so that the selection of post-processing method for cr is shown as follows:
The cb prediction (without post-processing) plus cb residuals are treated as golden
Choosing cr's post-processing method according to cb's post-processed prediction and golden
For example, if the cb's post-processed prediction is very similar to the golden, use cb's post-processing method as cr's post-processing method.

### Delta-Pred LM

A novel LM method is proposed in this section. Different from the CCLM as disclosed earlier in the background section, the inputs of deriving model parameters are the predicted samples (used as X) for the first component and the delta samples (used as Y) between reconstructed and predicted samples for the first component. The derived parameters and the initial predicted samples of the second component can decide the current predicted samples of the second component. For example, the predictors of cb and cr can be calculated based on:

$$delta\_cb = alpha * initial\_pred \_cb + beta ,$$

$$pred\_cb = initial\_pred \_cb + delta\_cb ,$$

$$delta\_cr = alpha * initial\_pred \_cr - beta ,$$

$$pred\_cr = initial\_pred \_cr + delta\_cr .$$

For another example, the predictors of cb and cr can be calculated as:

$$delta\_cb = alpha * initial\_pred \_cb + beta ,$$

$$pred\_cb = initial\_pred \_cb + delta\_cb ,$$

$$delta\_cr = - alpha * initial\_pred \_cr + beta ,$$

$$pred\_cr = initial\_pred \_cr + delta\_cr .$$

Embodiments for pred-reco LM can be used for delta-pred LM.

### Pred-Reco LM

A novel LM method is proposed in this section. Different from the CCLM as disclosed earlier in the background section, the inputs of deriving model parameters are the predicted samples (used as X) for the first component and the reconstructed samples (used as Y) for the first component. The derived parameters and the initial predicted samples of the second component can decide the current predicted samples of the second component. For example, the predictors of cb and cr can be calculated based on:

$$Pred\_cb = alpha * initial\_pred \_cb + beta$$

$$Pred\_cr = alpha * initial\_pred \_cr - beta$$

For another example, the predictors of cb and cr can be calculated as

$$Pred\_cb = alpha * initial\_pred \_cb + beta ,$$

$$Pred\_cr = - alpha * initial\_pred \_cr - beta .$$

In one embodiment, the first component is luma and the second component is cb or cr.

In another embodiment, the first component is cb and the second component is cr.

In another embodiment, the first component is weighted cb and cr and the second component is luma, where inverse LM is applied. For example, the inputs of deriving model parameters are the weighted predictions of cb and cr and the weighted reconstructed samples of cb and cr.

In one sub-embodiment, the weight for (cb, cr) can be equal.

In another sub-embodiment, the weight for (cb, cr) can be (1, 3) or (3, 1). Take (3, 1) as an example, the weighting formula can be:

$$weighted\_pred = ( 3 * pred\_cb + 1 * pred\_cr + offset ) ≫ 2 ,$$

$$weighted\_reco = ( 3 * reco\_cb + 1 * reco\_cr + offset ) ≫ 2.$$

In another embodiment, the initial predicted samples of the second component are generated by chroma DM.

In another embodiment, the initial prediction samples of the second component are generated by one or more traditional intra prediction modes (e.g. angular intra prediction modes, DC, planar).

### Prediction-Based LM

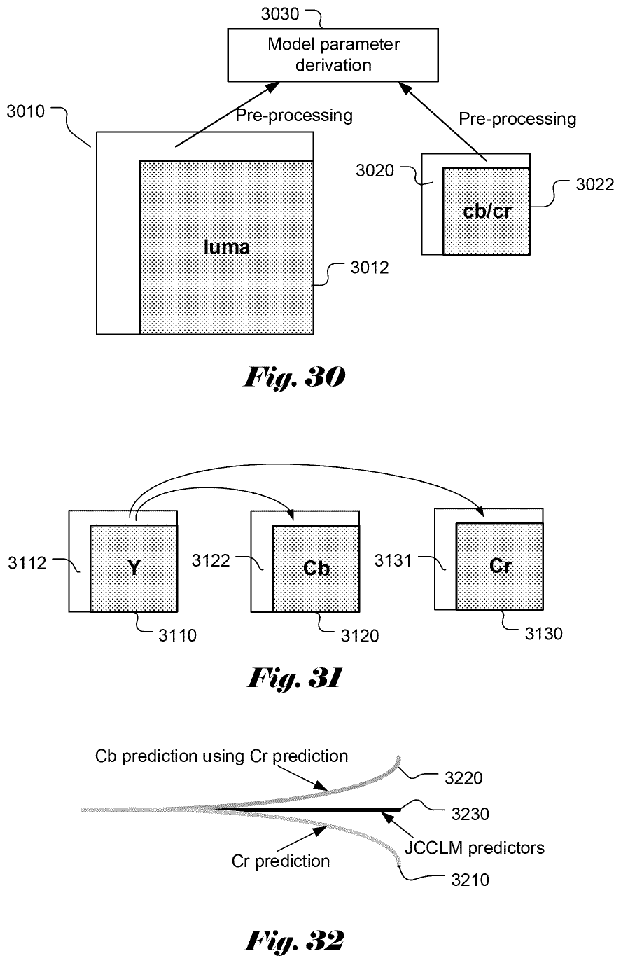

A novel LM method is proposed in the present invention. Different from the CCLM as described above where the model parameters are applied to reconstructed samples for the first component, the derived model parameters according to the present invention are applied to the predicted samples for the first component to get the predicted samples for the second or third component. An example of the prediction-based LM is shown in FIG. 31, where the predicted samples from luma (i.e., pred′_{L}(i, j)) is used to predict the chroma signal (i.e., P(i,j)):

$$P ( i , j ) = a \cdot {pred}_{L}^{′} ( i , j ) + b$$

While the example in FIG. 31 derives prediction for chroma based on luma, the present invention can derive prediction for any colour component based on another colour component. In one embodiment, the first component is luma.

In one sub-embodiment, the predicted samples for the first component are down-sampling with the down-sampling filters. For example, the down-sampling filters follow the original LM design. For another example, the down-sampling filters will not access neighbouring predicted/reconstructed samples. At the boundary of the current block, if the neighbouring samples are required to be the input samples of down-sampling filters, padded predicted values from the boundary of current block is used instead.

In another embodiment, the second component is Cb.

In another embodiment, the third component is Cr.

The following shows a flow of prediction-based inter CCLM.
Improve inter chroma prediction by linearly predicting chroma samples from luma samples
The linear predicting method can be one of
   CCLM_LT, CCLM_L, CCLM_T
   MMLM_LT, MMLM_L, MMLM_T
Steps:
   Step 1: Derive the linear model by neighbouring luma and chroma reconstructed samples
   Step 2: Apply the derived linear model to current luma predicted samples to get current chroma predicted samples

$${pred}_{CCLM} ( i , j ) = α \cdot {pred}_{L}^{′} ( i , j ) + β$$

pred_{L}′(i, j): down-sampled current luma predicted samples
   At the boundary inside the current block, padding is used

In the above, CCLM_LT, CCLM_L, CCLM_T, MMLM_LT, MMLM_L, and MMLM_T are all referred as LM modes in this disclosure.

### Joint LM

Different from CCLM as disclosed earlier, joint linear model is proposed to share a single model for chroma components (cb and cr).

In one embodiment, the parameters of the derived single model include alpha and beta. For example, the predictors of cb and cr can be calculated based on luma reconstructed samples and the parameters.

$$Pred\_cb = alpha * reco\_luma + beta ,$$

$$Pred\_cr = alpha * reco\_luma - beta .$$

For another example, the predictors of cb and cr can be calculated as

$$Pred\_cb = alpha * reco\_luma + beta ,$$

$$Pred\_cr = - alpha * reco\_luma + beta .$$

In another embodiment, when deriving model parameters, luma, cb, and cr are used. The luma parts are kept as original and the chroma parts are changed. For example, the cb's and cr's reconstructed neighbouring samples are weighted before being the inputs of deriving model parameters. The weighted method can be any one or any combination of the methods to be described in section JCCLM-method 1/-method 2.

In another embodiment, when deriving model parameters, luma and one of chroma components are used. For example, luma and cb are used to decide model parameters.

In another embodiment, instead of using neighbouring reconstructed samples, neighbouring residuals are used for deriving model parameters. Then, the joint residuals of cb and cr are derived as follows:

$${resi}_{C} ( i , j ) = a \cdot res {i}_{L}^{′ ( i , j )} + b$$

In one sub-embodiment, if JCCR is applied, LM parameters for Cb and Cr are the same (i.e., joint LM is applied).

In another sub-embodiment, the neighbouring residuals for chroma are the weighted sum of neighbouring cb and cr residuals.

In another sub-embodiment, if joint LM is applied, JCCR is inferred as enabled.

In another sub-embodiment, when joint LM is used, the prediction of current chroma block is generated by chroma DM mode.

In another sub-embodiment, when joint LM is used, an initial prediction of current chroma block is generated by chroma DM mode and the final prediction of current chroma block is generated based on the initial prediction and resi_{C}. (e.g. initial prediction+resi_{C})

### Residual LM

Instead of using neighbouring reconstructed samples, neighbouring residuals are used for deriving model parameters. Then, the joint residuals of current chroma block are derived as follows. (cb and cr have their own models, respectively.)

$${resi}_{C} ( i , j ) = a \cdot res {i}_{L}^{′ ( i , j )} + b$$

In one embodiment, the prediction of current chroma block (denoted as pred_c) is generated by chroma DM and the reconstruction of current chroma block is formed by pred_c+resi_c.

In another embodiment, an initial prediction of current chroma block is generated by chroma DM mode and the final prediction of current chroma block is generated based on the initial prediction and resi_{C}. (e.g. initial prediction+resi_{C}).

JCCLM (JCCR with CCLM)—Method 1

JCCLM-mothod1 is proposed as a novel LM derivation scheme. Different from the CCLM as disclosed earlier in the background section, neighbouring luma reconstructed samples and weighted reconstructed neighbouring cb and cr samples are used as the inputs X and Y of model derivation. The derived model is called as JCCLM and the model parameters are called as JCCLM parameters in this disclosure. Then, JCCLM predictors are decided according to JCCLM parameters and reconstructed samples of the collocated luma block. Finally, the predictions for cb and cr are calculated by the JCCLM predictors.

In one embodiment, the weighting for generating weighted reconstructed neighbouring cb and cr samples can be (1, −1) for (cb, cr).

In another embodiment, the weighting for generating weighted reconstructed neighbouring cb and cr samples can be (½, ½) for (cb, cr).

In another embodiment, the predictions for cb and cr are calculated as follows:

$$pred\_cb = 1 * JCCLM\_predictor , pred\_cr = - 1 * JCCLM\_predictor + k$$

In another sub-embodiment, k can be any positive value. For example, k=512.

In another sub-embodiment, k varies with the bit depth. For example, if the bit depth is 10, k=512.

In another sub-embodiment, k is pre-defined in the standard or depends on the signalling at block, SPS, PPS, and/or picture level.

In another embodiment, the predictions for cb and cr are calculated as follows:

$$pred\_cb = 1 * JCCLM\_predictor , pred\_cr = 1 * JCCLM\_predictor .$$

In another embodiment, when the weighting for generating weighted reconstructed neighbouring cb and cr samples is (1, −1) for (cb, cr), the predictions for cb and cr are calculated as follows:

$$pred\_cb = 1 * JCCLM\_predictor , pred\_cr = - 1 * JCCLM\_predictor + k$$

In the above equation, the value of k can reference the sub-embodiments mentioned above. In another embodiment, when the weighting for generating weighted reconstructed neighbouring cb and cr samples is (½, ½) for (cb, cr), the predictions for cb and cr are calculated as follows.

$$pred\_cb = 1 * JCCLM\_predictor , pred\_cr = 1 * JCCLM\_predictor$$

In another embodiment, when JCCLM is applied, residual coding use JCCR automatically.

JCCLM (JCCR with CCLM)—Method 2

JCCLM-method 2 is proposed as a novel LM derivation scheme. Different from the CCLM as disclosed earlier in the background section, two models are used for generating prediction of the current block. The derivation process of the two models and their corresponding predictors are shown below:
JCCLM: Neighbouring luma reconstructed samples and weighted reconstructed neighbouring cb and cr samples are used as the inputs X and Y of model derivation. The derived model is called as JCCLM and the model parameters are called as JCCLM parameters in this disclosure. Then, JCCLM predictors are decided according to JCCLM parameters and reconstructed samples of the collocated luma block.
Cb_CCLM: Neighbouring luma reconstructed samples and neighbouring cb reconstructed samples are used as the inputs X and Y of model derivation. The derived model is called as cb_CCLM and the model parameters are called as cb_CCLM parameters in this disclosure. Then, cb_CCLM predictors are decided according to cb_CCLM parameters and reconstructed samples of the collocated luma block.

Finally, the predictions for cb and cr are calculated by the JCCLM predictors and cb_CCLM predictors. FIG. 32 illustrates an example of the relationship between the cr prediction 3210, cb prediction 3220 and JCCLM predictors 3230.

In one embodiment, the weighting for generating weighted reconstructed neighbouring cb and cr samples can be (½, ½) for (cb, cr).

In another embodiment, the prediction for cb is calculated as follows:

$$pred\_cb = cb\_CCLM \_predictors .$$

In another embodiment, the prediction for cr is calculated as follows:

$$pred\_cr = 2 * JCCLM\_predictor - cb\_CCLM \_predictor$$

In another embodiment, when JCCLM is applied, residual coding uses JCCR automatically.

### Multiple-Hypothesis of CCLM Prediction

In addition to CCLM as disclosed earlier in the background section (for cb, deriving model parameters from luma and cb; for cr, deriving model parameters from luma and cr), more CCLM variations are disclosed. The following shows some examples.
In one variation, cr prediction is derived by:
   Deriving model parameters by using neighbouring reconstructed samples of cb and cr as the inputs X and Y of model derivation
   Then generating cr prediction by the derived model parameters and cb reconstructed samples.
In another variation, MMLM is used.
In yet another variation, model parameters for cb (or cr) prediction are derived from multiple collocated luma blocks.

Each CCLM method is suitable for different scenarios. For some complex features, the combined prediction may result in better performance. Therefore, multiple-hypothesis CCLM is disclose to blend the predictions from multiple CCLM methods. The to-be-blended CCLM methods can be from (but are not limited to) the above mentioned CCLM methods. A weighting scheme is used for blending.

In one embodiment, the weights for different CCLM methods are pre-defined at encoder and decoder.

In another embodiment, the weights vary based on the distance between the sample (or region) positions and the reference sample positions.

In another embodiment, the weights depend on the neighbouring coding information.

In another embodiment, a weight index is signalled/parsed. The code words can be fixed or vary adaptively. For example, the code words vary with template-based methods.

### Adaptive Intra-Mode Selection

With improvement of video coding, more coding tools are created. The syntax overhead of selecting a coding tool becomes an issue. Several straightforward methods can be used to reduce the syntax overhead. For example, a large block can use the same coding mode. In another example, multiple components (e.g. cb and cr) can share the same coding mode.

However, with these straightforward methods, the accuracy/performance for intra prediction decreases. The possible reasons may be following:
Intra prediction is highly related to neighbouring reference samples. When the whole block uses a single intra prediction mode, the intra prediction mode may be suitable for those samples which are close to the reference samples but may not be good for those samples which are far away from the reference samples.
when processing cr, the reconstructions of cb and luma were generated and can be used to choose the coding mode for cr.

In this section, it is proposed to adaptively change the intra prediction mode for one or more sample(s) or subblock(s) within the current block according to previous coding/decoding of components.

In one embodiment, with the reconstruction of the previously encoded/decoded components, the performance for the different coding modes is decided. Then, the better mode is used for the rest component(s) (subsequently encoded and decoded component(s)). For example, for cb, if the prediction from traditional intra prediction modes (e.g. angular intra prediction modes, DC, planar) is better than the prediction from LM mode. (e.g. “better” means similar to cb's reconstruction.) Then, the traditional intra prediction mode is preferable for cr.

In one sub-embodiment, the proposed method can be subblock based. For example, a chroma block is divided into several sub-blocks. For each subblock, if for cb, the subblock's prediction from LM mode is better than the subblock's prediction from traditional intra prediction modes (e.g. angular intra prediction modes, DC, planar). (e.g. “better” means similar to cb's reconstruction and reducing the cb's residual), then the LM mode is preferable for the corresponding subblock of cr. An example is shown in FIG. 33, where the chroma block is divided into 4 sub-blocks. If sub-blocks 1 and 2 of cb block 3310 have better prediction results using LM mode, then sub-blocks 1 and 2 of cr block 3320 also use LM mode.

In another embodiment, the adaptive changing rule can be performed at both encoder and/or decoder and doesn't need an additional syntax.

### Inverse LM

For the CCLM mode as disclosed earlier in the background section, luma reconstructed samples are used to derive the predictors in the chroma block. In this disclosure, inverse LM is proposed to use chroma information to derive the predictors in the luma block. When supporting inverse LM, chroma are encoded/decoded (signalled/parsed) before luma.

In one embodiment, the chroma information refers to the chroma reconstructed samples. When deriving model parameters for inverse LM, reconstructed neighbouring chroma samples are used as X and reconstructed neighbouring luma samples are used as Y. Moreover, the reconstructed samples in the chroma block (collocated to the current luma block) and the derived parameters are used to generate the predictors in the current luma block. An alternative way is that “information” in this embodiment can refer to predicted samples.

In one embodiment, chroma refers to cb and/or cr component(s).

In one sub-embodiment, only one of cb's and cr's information is used.

In another sub-embodiment, the chroma information is from both cb and cr. For example, the neighbouring reconstructed cb and cr samples are weighted and then used as the inputs of deriving model parameters. In another example, the reconstructed cb and cr samples in the chroma block (collocated with the current luma block) are weighted and then used to derive the predictors in the current luma block.

In another embodiment, for the current luma block, the prediction (generated by the proposed inverse LM) can be combined with one or more hypotheses of predictions (generated by one or more other intra prediction modes).

In one sub-embodiment, “other intra prediction modes” can refer to angular intra prediction modes, DC, planar, MIP, ISP, MRL, any other existing intra modes (supported in HEVC/VVC) and/or any other intra prediction modes.

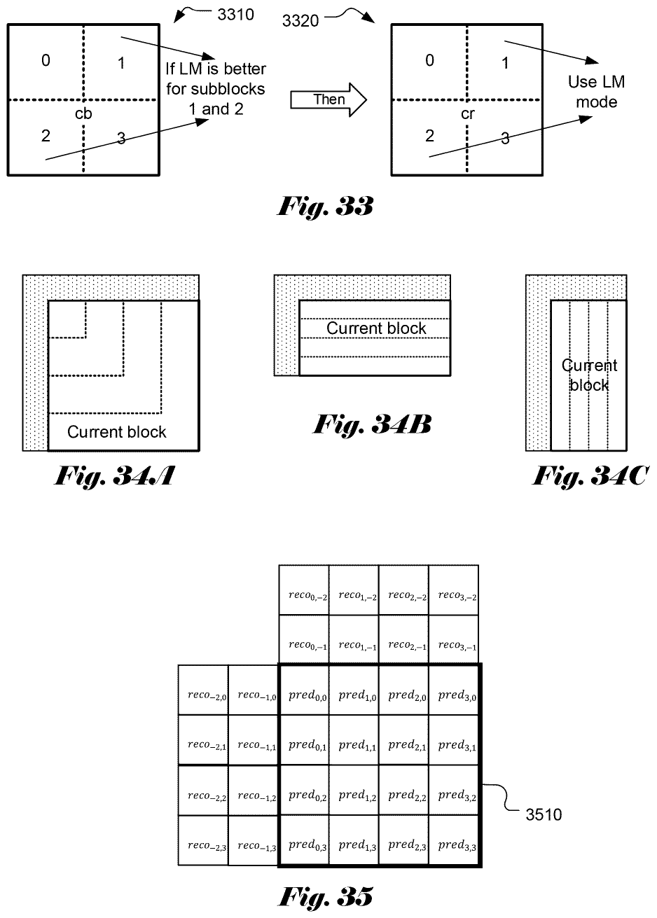

In another sub-embodiment, when combining multiple hypotheses of predictions, weighting for each hypothesis can be fixed or adaptively changed. For example, equal weights are applied to each hypothesis. In another example, weights vary with neighbouring coding information, sample position, block width, height, prediction mode or area. Some examples of neighbouring coding information usage are shown as follows:
One possible rule related to sample position is described as follows.
   When the sample position is further away from the reference samples, the weight for the prediction from other intra prediction modes decreases.
Another possible rule related to neighbouring coding information is described as follows.
   When more neighbouring blocks (left, above, left-above, right-above, and/or left-bottom) are coded with a particular (e.g. Mode A), the weight for the prediction from Mode A gets higher.
Another possible rule related to sample position is described as follows.
   The current block is partitioned into several regions. The sample positions in the same region share the same weighting. If the current region is close to the reference L neighbour, the weight for prediction from other intra prediction modes is higher than the weight for prediction from CCLM. The following shows some possible ways to partition the current block. (as the dotted lines in the FIGS. 34A-C):
      FIG. 34A (ratio of width and height close to or exactly 1:1): The distance between the current region and the left and top reference L neighbour is considered.
      FIG. 34B (width>n*height, where n can be any positive integer): The distance between the current region and the top reference L neighbour is considered.
      FIG. 34C (height>n*width, where n can be any positive integer): The distance between the current region and the left reference L neighbour is considered.

### CCLM for Inter Block

As described earlier, cross-colour tools are used for intra blocks to improve chroma intra prediction. For an inter block, chroma prediction may not be as accurate as luma. Possible reasons are listed below:
Motion vectors for chroma components are inherited from luma, (Chroma doesn't have its own motion vectors.)
Less coding tools are designed to improve inter chroma prediction.

Therefore, using one or more cross-colour tools is proposed as an alternative way to code inter blocks. The following takes the cross-colour tool as CCLM for example. The proposed methods are not limited to only using CCLM as the cross-colour tool and can be applied to and/or combined with all or any subset of the cross-colour tools. With the proposed methods, chroma prediction according to luma for an inter block can be improved. According to CCLM for inter block (referred as inter CCLM in this disclosure), the corresponding luma block is coded in the inter mode, i.e., using motion compensation and one or more motion vectors to access previous reconstructed luma blocks in one or more previously coded reference frames. Cross-colour linear mode based on this inter-coded luma may provide better prediction than the inter prediction based on previous reconstructed chroma blocks in one or more previously coded reference frames. The CCLM for intra mode has been described previously. The CCLM process described earlier can be applied here. However, while the conventional CCLM utilizes a reconstructed luma block with the reference samples (for predicting or reconstructing the luma block) located in the current frame, CCLM inter mode utilizes a reconstructed or predicted luma block with the reference samples (for predicting or reconstructing the luma block) located in one or more previously coded reference frames.

In one embodiment, for chroma components, in addition to or instead of original inter prediction (generated by motion compensation from a target inter mode), one or more hypotheses of cross-colour predictions (generated by any cross-colour tools such as CCLM and/or any other LM modes) are used to form the current prediction. The cross-colour tools mean to use more than one colour information to generate one or more cross-colour predictions by using a pre-defined generation method. The usage of the more than one colour information and the pre-defined generation method for CCLM are described in the sub-section entitled: CCLM (Cross Component Linear Model). For CCLM, the model parameters a and b are derived based on reconstructed neighbouring luma and chroma samples and the derived model parameters are applied to the reconstructed luma samples in the collocated luma block as expression (1). In this case, the number of model parameters (only including a and b) is 2 and for generating the predicted value for (i, j) in the current chroma block, only one down-sampled collocated luma sample for (i, j) is used and combined with the model parameter a. The present invention is not limited to setting the number of model parameters as 2 and using only one down-sampling collocated luma sample for generating the predicted value at a position in the chroma block. The number of model parameters can be any pre-defined number, the collocated luma samples can be without down-sampling, and/or the number of the collocated luma samples (which will be combined with the model parameter(s)) can be any pre-defined number. For more variations of cross-colour tools, the more than one colour information includes the reconstructed samples of the collocated first colour (e.g. luma and/or the first chroma component) block, the reconstructed samples of a pre-defined neighbouring region of the collocated first colour block, and/or the reconstructed samples of a pre-defined neighbouring region of the second colour (e.g. current chroma component) block. For example, the pre-defined neighbouring region of the collocated first colour block and the pre-defined neighbouring region of the second colour block are used to derive the model parameters and the derived model parameters are applied to the reconstructed samples of the collocated first colour block to generate the cross-colour prediction of the current second colour block. For the alternative prediction-based cross-colour tools, the more than one colour information can be any subset of the above-mentioned information and/or further include the predicted samples by using the target inter mode of the collocated first colour block, the predicted samples from the target inter mode of a pre-defined neighbouring region of the collocated first colour (e.g. luma) block, and/or the predicted samples by using the target inter mode of a pre-defined neighbouring region of the second colour (e.g. current chroma component) block. For example, the predicted samples by using the target inter mode of the collocated first colour block and the predicted samples by using the target inter mode of the second colour block are used to derive the model parameters and the derived model parameters are applied to the reconstructed samples of the collocated first colour block to generate the cross-colour prediction of the current second colour block. The usage of the more than one colour information may depend on the block width, block height, and/or block area. If the block width/height/area is smaller than a pre-defined threshold, in addition to using the mentioned samples (e.g. the predicted samples of the collocated first colour block and the predicted samples of the second colour block) to derive the model parameters, the neighbouring predicted or reconstructed samples are used. The pre-defined neighbouring region may include top neighbouring region with N rows, left neighbouring region with M columns, top-left neighbouring region with M×N samples, or any subset of above-mentioned regions. More cross-colour tools can be found in the paragraph mentioning the term “LM” in this disclosure.

In one sub-embodiment, the current prediction is the weighted sum of inter prediction and CCLM prediction. Weights are designed according to neighbouring coding information, sample position, block width, height, mode or area. Some examples are shown as follows:
In one example, for a small block (e.g. area<threshold), weights for CCLM prediction are higher than weights for inter prediction.
In another example, when most neighbouring coded blocks are intra blocks, weights for CCLM prediction are higher than weights for inter prediction.
In yet another example, weights are fixed values for the whole block.

In another embodiment, the inter prediction can be generated by any inter mode mentioned above. For example, the inter mode can be regular merge mode. For another example, the inter mode can be CIIP mode. For another example, the inter mode can be CIIP PDPC. For another example, the inter mode can be GPM or any GPM variations (e.g. GPM intra).

In one sub-embodiment, the regular merge mode is a merge candidate selected from the merge candidate list with a signalled merge index.

In another sub-embodiment, the regular merge mode can be MMVD.

In another sub-embodiment, the LM mode used in inter CCLM is prediction-based LM.

In another embodiment, inter CCLM is supported only when any one (or more than one) of the pre-defined inter modes is used for the current block, or inter CCLM is supported when any one (or more than one) of the enabling flag(s) of the pre-defined inter mode is (are) indicated as enabled. The meaning of supporting inter CCLM is that the prediction of the current block can be chosen between applying inter CCLM or not applying inter CCLM.

In one sub-embodiment: blending one or more hypotheses of predictions (generated by CCLM and/or any other LM modes) with original inter prediction. When applying inter CCLM, the prediction of current block is generated by:
Blending the chroma prediction for existing inter mode and the prediction from LM

$$Blending : {Pred}_{final} = ( {w}_{m e r g e} * Pre {d}_{Inter} + {w}_{LM} * Pre {d}_{LM} + 2 ) ≫ 2$$

Weighting rule: w_{Inter} and w_{LM},
   For example:
      If both top and left are intra, (w_{Inter}, w_{LM})=(1, 3)
      Otherwise, if one of top and left is intra, (w_{Inter}, w_{LM})=(2, 2)
      Otherwise, (w_{Inter}, w_{LM})=(3, 1)
   For another example, the weighting follows CIIP weighting.
      For example, pred_{Inter}=inter prediction after OBMC (if OBMC is used)
      For another example, pred_{Inter}=inter prediction before OBMC (OBMC can be applied after blending)

In another sub-embodiment: replacing original inter prediction with one or more hypotheses of predictions (generated by CCLM and/or any other LM modes).

When not applying inter CCLM, the prediction of the current block is from the original inter prediction.

In another embodiment, the choice between applying inter CCLM or not applying inter CCLM depends on signalling. The signalling can be at TU/TB, CU/CB, PU/PB, or CTU/CTB.

In one sub-embodiment, one or more flags are signalled in the bitstream to indicate whether to apply inter CCLM or not. For example, the flag is context coded. For another example, only one context is used to code the flag. For another example, multiple contexts are used to code the flag and the selection of the contexts depends on block width, block height, block area, or neighbouring mode information.

In another sub-embodiment, when the signalling indicates to apply inter CCLM, additional signalling is used to select one or more than one LM from total candidate LM modes (e.g. CCLM_LT, CCLM_L, CCLM_T, MMLM_L, MMLM_T, MMLM_L, or any subset/extension from the above mentioned modes). For example, if one LM mode is selected, the LM prediction is generated by the selected LM. For another example, if more than one LM modes are selected the LM prediction is generated by blending hypotheses of predictions from multiple LM modes. For another example, the additional signalling refers to an index in the bitstream which can be truncated unary coding with and/or without contexts.

In another sub-embodiment, when the signalling indicates to apply inter CCLM, one or more LM from total candidate LM modes (e.g. CCLM_LT, CCLM_L, CCLM_T, MMLM_L, MMLM_T, MMLM_L, or any subset/extension from the above mentioned modes) is (are) implicitly selected (or predefined) to be used in inter CCLM.

For example, CCLM_LT is used to generate LM prediction for inter CCLM. For another example, MMLM_LT is used to generate LM prediction for inter CCLM. For another example, the predefined rule depends on block width, block height, or block area as follows:
Boundary matching setting (used as the predefined rule) can be applied only when the block width, block height, or block area is larger than a threshold.
Boundary matching setting (used as the predefined rule) can be applied only when the block width, block height, or block area is smaller than a threshold.
When the block width, block height, or block area is smaller than a threshold, the selected LM mode(s) is(are) inferred as any one (more than one) LM mode(s) from total candidate LM modes.
   The selected LM mode is fixed as CCLM_LT.
   The selected LM mode is fixed as MMLM_LT.

For another example, the predefined rule depends on boundary matching setting. Details of boundary matching setting is described later in the section of boundary matching setting. The candidate mode used in the section of boundary matching setting refers to each candidate LM mode for inter CCLM. The prediction from a candidate mode used in the section of boundary matching setting refers to the prediction generated by each candidate LM mode or refers to the blended prediction from each candidate LM mode and original inter mode.

In another embodiment, inter CCLM can be supported only when the size conditions of the current block are satisfied.

In one sub-embodiment, the size condition is that the block width, block height, or block area is larger than a pre-defined threshold. The predefine threshold can a positive integer such as 8, 16, 32, 64, 128, 256, etc.

In another sub-embodiment, the size condition is that the block width, block height, or block area is smaller than a pre-defined threshold. The predefine threshold can a positive integer such as 8, 16, 32, 64, 128, 256, 512, 1024, 2048, 4096, etc.

In another embodiment, the inter mode used in the inter block depends on an enabling flag. For example, if the inter mode is regular merge, the enabling flag is referred as a regular merge flag. For another example, if the inter mode is CIIP, the enabling flag is referred as CIIP flag. For another example, if the inter mode is CIIP PDPC, the enabling flag is referred as CIIP PDPC Flag. For another example, the enabling flag indicated as enabled (e.g. flag value equal to 1) means the corresponding inter mode is applied to the current block. For another example, the enabling flag indicated as disabled (e.g. flag value equal to 0) means the corresponding inter mode is not applied to the current block. For another example, the enabling flag is signalled in the bitstream and/or inferred in some cases. For another example, the signalling of the enabling flag depends on block width, block height, or block area.

In another embodiment, the prediction from inter can be adjusted by the neighbouring reconstructed samples and a pre-defined weighting scheme. For example, when the current block is coded in a merge mode, the prediction from merge is blended with the neighbouring reconstructed samples. For another example, the proposed scheme is enabled depending on CIIP PDPC flag, where the CIIP PDPC flag may be signalled when the CIIP flag is indicated as enabled. For another example, the pre-defined weighting scheme follows PDPC weighting.

An example of detailed process is described as follows:
Inter-predictor of regular merge mode is refined using the above R_{x,-1} and left R_{-1,y} reconstructed samples
Derivation of nScale and wT & wL are the same as in intra planar mode

$$w T = 32 ≫ ( ( {y}^{′} ≪ 1 ) ≫ nScale )$$

$$wL = 32 ≫ ( ( {x}^{′} ≪ 1 ) ≫ nScale )$$

$$nScale = ( floorLog 2 ( width ) + floorLog 2 ( height ) - 2 ) ≫ 2 ;$$

CIIP PDPC:
   If LMCS is enabled, inter-predictor is computed in mapped domain

$$Pred ( x , y ) = ( ( ( ( w T \times {R}_{x , - 1} + w L \times {R}_{- 1 , y} + 32 ) ≫ 6 ) ≪ 6 ) + ( 64 - w T - w L ) \times F w d ( p redInte r ( x , y ) ) + 32 ) ≫ 6$$

Otherwise, inter-predictor is computed in original domain

$$Pred ( x , y ) = ( ( ( ( w T \times {R}_{x , - 1} + w L \times {R}_{- 1 , y} + 32 ) ≫ 6 ) ≪ 6 ) + ( 64 - w T - w L ) \times p redInte r ( x , y ) + 32 ) ≫ 6$$

When CIIP flag is true, CIIP PDPC flag is further signalled to indicate whether to use CIIP PDPC

In another embodiment, original inter prediction (generated by motion compensation) is used for luma and the predictions of chroma components are generated by CCLM and/or any other LM modes.

In one sub-embodiment, the current CU is viewed as an inter CU, intra CU, or a new type of prediction mode (neither intra nor inter).

The above proposed methods can be also applied to IBC blocks. (“inter” in this section can be changed to IBC or any other non-intra mode.) For example, the target inter mode is changed to the target IBC mode. As mentioned earlier regarding the mechanism of intra block copy, the prediction generated by the target mode is copied from the reconstructed samples in the current frame by using block vectors wherein the block vectors are signalled/parsed at encoder/decoder and/or derived implicitly. For example, the block vectors are determined implicitly by using template matching in a predefined search range to find the best prediction block from the reconstructed part of the current frame. For example, the template is the L-shape neighboring region and the template matching means to find a template in the search range which is the most similar to the template for the current block. When applying the proposed methods to the block coded with the target IBC mode, for chroma components, the block vector prediction can be combined or replaced by the cross-colour prediction.

### Boundary-Matching Setting

When boundary-matching setting is used, a boundary matching cost for a candidate mode refers to the discontinuity measurement (including top boundary matching and/or left boundary matching) between the current prediction (i.e., the predicted samples within the current block) generated from the candidate mode, and the neighbouring reconstruction (i.e., the reconstructed samples within one or more neighbouring blocks) as shown in FIG. 35, where pred_{i,j} refers to a predicted block, reco_{i,j} refers to a neighbouring reconstructed block and block 3510 (as shown in a thick-line box) corresponds to the current block. Top boundary matching means the comparison between the current top predicted samples and the neighbouring top reconstructed samples, and left boundary matching means the comparison between the current left predicted samples and the neighbouring left reconstructed samples.

In another sub-embodiment, the candidate mode with the smallest boundary matching cost is applied to the current block.

In another embodiment, the boundary matching cost for Cb and Cr can be added to become the boundary matching cost for chroma, so that the selected candidate mode for Cb and Cr will be shared. Accordingly, the selected candidate mode for Cb and Cr will be the same.

In another embodiment, the selected candidate modes for Cb and Cr depend on the boundary matching costs for Cb and Cr, respectively, so the selected candidate modes for Cb and Cr can be the same or different.

In one embodiment, a pre-defined subset of the current prediction is used to calculate the boundary matching cost. n line(s) of top boundary within the current block and/or m line(s) of left boundary within the current block are used. (Moreover, n2 line(s) of top neighbouring reconstruction and/or m2 line(s) of left neighbouring reconstruction are used.)

In an example of calculating a boundary matching cost, n=2, m=2, n2=2, and m2=2:

$$cost = {\sum }_{x = o}^{block width} ( \vert a * {pred}_{x , 0} - b * p r e {d}_{x , 1} - c * r e c {o}_{x , - 1} \vert + \vert d * {reco}_{x , - 1} - e * p r e {d}_{x , 0} - f * r e c {o}_{x , - 2} \vert ) + {\sum }_{y = o}^{block height} ( \vert g * pre {d}_{0 , y} - h * p r e {d}_{1 , y} - i * r e c {o}_{- 1 , y} \vert + \vert j * rec {o}_{- 1 , y} - k * p r e {d}_{0 , y} - l * r e c {o}_{- 2 , y} \vert ) .$$

In the above equation, the weights (a, b, c, d, e, f, g, h, i, j, k, 1) can be any positive integers such as a=2, b=1, c=1, d=2, e=1, f=1, g=2, h=1, i=1, j=2, k=1, and l=1.

In another example of calculating a boundary matching cost, n=2, m=2, n2=1 and m2=1:

$$cost = {\sum }_{x = o}^{block width} ( \vert a * pre {d}_{x , 0} - b * p r e {d}_{x , 1} - c * r e c {o}_{x , - 1} \vert ) + {\sum }_{y = o}^{block height} ( \vert g * pre {d}_{0 , y} - h * p r e {d}_{1 , y} - i * r e c {o}_{- 1 , y} \vert ) .$$

In the above equation, the weights (a, b, c, g, h, and i) can be any positive integers such as a=2, b=1, c=1, g=2, h=1, and i=1.

In yet another example of calculating a boundary matching cost, n=1, m=1, n2=2, and m2=2:

$$cost = {\sum }_{x = o}^{block width} ( \vert d * rec {o}_{x , - 1} - e * p r e {d}_{x , 0} - f * r e c {o}_{x , - 2} \vert ) + {\sum }_{y = o}^{block height} ( \vert j * rec {o}_{- 1 , y} - k * p r e {d}_{0 , y} - l * r e c {o}_{- 2 , y} \vert ) .$$

In the above equation, the weights (d, e, f, j, k, and l) can be any positive integers such as d=2, e=1, f=1, j=2, k=1, and l=1.

In yet another example of calculating a boundary matching cost, n=1, m=1, n2=1, and m2=1:

$$cost = {\sum }_{x = o}^{block width} \vert a * pre {d}_{x , 0} - c * r e c {o}_{x , - 1} \vert + {\sum }_{y = o}^{block height} \vert g * pre {d}_{0 , y} - i * r e c {o}_{- 1 , y} \vert .$$

In the above equation, the weights (a, c, g, and i) can be any positive integers such as a=1, c=1, g=1, and i=1.

In yet another example of calculating a boundary matching cost, n=2, m=1, n2=2, and m2=1:

$$cost = {\sum }_{x = o}^{block width} ( \vert a * pre {d}_{x , 0} - b * p r e {d}_{x , 1} - c * r e c {o}_{x , - 1} \vert + \vert d * rec {o}_{x , - 1} - e * p r e {d}_{x , 0} - f * r e c {o}_{x , - 2} \vert ) + {\sum }_{y = o}^{block height} ( \vert g * pre {d}_{0 , y} - i * r e c {o}_{- 1 , y} \vert ) .$$

In the above equation, the weights (a, b, c, d, e, f, g, and i) can be any positive integers such as a=2, b=1, c=1, d=2, e=1, f=1, g=1, and i=1.

In yet another example of calculating a boundary matching cost, n=1, m=2, n2=1, and m2=2:

$$cost = {\sum }_{x = o}^{block width} ( \vert a * pre {d}_{x , 0} - c * r e c {o}_{x , - 1} \vert ) + {\sum }_{y = o}^{block height} ( \vert g * pre {d}_{0 , y} - h * p r e {d}_{1 , y} - i * r e c {o}_{- 1 , y} \vert + \vert j * rec {o}_{- 1 , y} - k * p r e {d}_{0 , y} - l * r e c {o}_{- 2 , y} \vert ) .$$

In the above equation, the weights (a, c, g, h, i, j, k, and l) can be any positive integers such as a=1, c=1, g=2, h=1, i=1, j=2, k=1, and l=1.

The following examples for n and m can also be applied to n2 and m2.

For another example, n can be any positive integer such as 1, 2, 3, 4, etc.

For another example, m can be any positive integer such as 1, 2, 3, 4, etc.

For another example, n and/or m vary with block width, height, or area. In one embodiment, m gets larger for a larger block (e.g. area>threshold2). For example,
Threshold2=64, 128, or 256.
When area>threshold2, m is increased to 2. (Originally, m is 1.)
When area>threshold2, m is increased to 4. (Originally, m is 1 or 2.)

In another example, m gets larger and/or n gets smaller for a taller block (e.g. height>thrershold2*width). For example,
Threshold2=1, 2, or 4.
When height>thrershold2*width, m is increased to 2. (Originally, m is 1.)
When height>thrershold2*width, m is increased to 4. (Originally, m is 1 or 2.)

In another embodiment, n gets larger for a larger block (area>threshold2).
Threshold2=64, 128, or 256.
When area>threshold2, n is increased to 2. (Originally, n is 1.)
When area>threshold2, n is increased to 4. (Originally, n is 1 or 2.)

In another embodiment, n gets larger and/or m gets smaller for a wider block (width>thrershold2*height). For example,
Threshold2=1, 2, or 4.
When width>thrershold2*height, n is increased to 2. (Originally, n is 1.)
When width>thrershold2*height, n is increased to 4. (Originally, n is 1 or 2.)

### Cross-CU LM

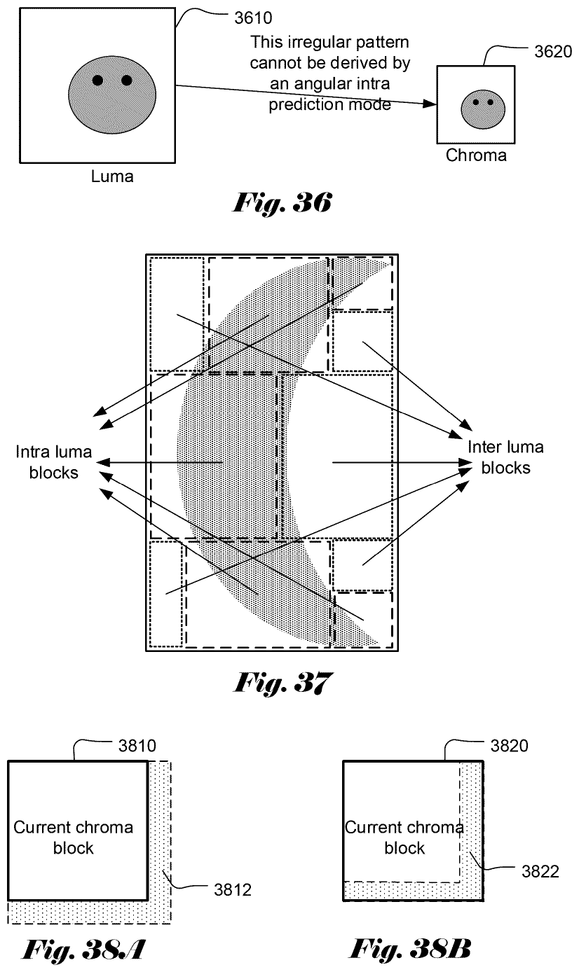

Compared with traditional intra prediction modes (e.g. angular intra prediction modes, DC, and planar), the benefit from LM mode is to predict irregular patterns as shown in FIG. 36, where the block has an irregular pattern that no angular intra prediction can provide a good prediction. However, the luma block 3610 can provide a good prediction for the chroma block 3620 using LM mode.

For encoding/decoding of irregular patterns in an inter picture, the distribution of intra and inter coding modes may look as follows. For some regions (highly related to neighbour), intra mode is used. For other regions, inter mode is preferable.

To handle the situation shown as above, a cross-CU LM mode is proposed. Based on the observation of current CU's ancestor node, LM mode is applied. For example, if the ancestor node contains irregular patterns (e.g. partial intra with partial inter), the blocks belonging to this ancestor node are encoded/decoded with LM mode. With the proposed method, the CU-level on/off flag for LM mode is not required. FIG. 37 illustrates an example that a luma picture area associated with a node contains irregular patterns. The area associated with the node is partitioned into luma blocks according to the irregular patterns. The luma blocks (the dashed-line blocks) that the irregular patterns occupy a noticeable portion of the blocks processed as intra blocks; and otherwise the luma blocks (the dotted-line blocks) are processed as inter luma blocks.

In one embodiment, the block-level on/off flag for LM mode is defined/signalled at the ancestor node level. For example, when the flag at the ancestor node indicates the cross-CU LM is enabled, the CUs belongs to (i.e., those partitioned from) the ancestor node use LM. In another example, when the flag at the ancestor node indicates the cross-CU LM is disabled, the CUs belongs to (i.e., those partitioned from) the ancestor node do not use LM.

In another embodiment, the ancestor node refers to a CTU.

In another embodiment, whether to enable cross-CU LM is implicitly derived according to the analysis of ancestor node's block properties.

In this section, CU can be changed to any block. For example, it can be PU.

### LM Assisted Angular/Planar Mode

For traditional intra prediction modes (e.g. angular intra prediction modes, DC, and planar), the reference samples are from top and left neighbouring reconstructed samples. Therefore, the accuracy of intra prediction decreases for right-bottom samples within the current block. In this section, LM is used to improve the prediction from traditional intra prediction modes.

In one embodiment, the current block's prediction is formed by a weighted sum of one or more hypotheses of predictions from traditional intra prediction mode(s) and one or more hypotheses of predictions from LM mode(s). In one sub-embodiment, equal weights are applied to both. In another sub-embodiment, weights vary with neighbouring coding information, sample position, block width, height, mode or area. For example, when the sample position is far away from the top-left region, the weight for the prediction from traditional intra prediction modes decreases. More weighting schemes can reference “inverse LM” section.

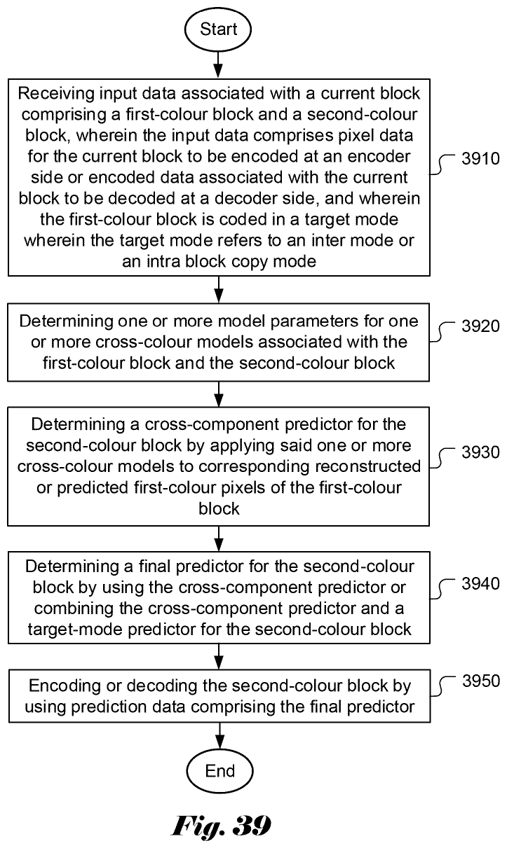

In another embodiment, it is proposed to use LM mode to generate the right-bottom region within or near the current block. When doing intra prediction, the reference samples can be based on not only original left and top neighbouring reconstructed samples but also proposed right and bottom LM-predicted samples. The following shows an example.
Before doing intra prediction for a chroma block, the collocated luma block is reconstructed.
“The neighbouring luma reconstructed samples of the collocated luma block” and “the neighbouring chroma reconstructed samples of the current chroma block” are used for deriving LM parameters.
“The reconstructed samples of the collocated luma block” with the derived parameters are used for obtaining the right-bottom LM-predicted samples of the current chroma block. Right-bottom region of the current chroma block can be any subset of the region in FIGS. 38A-B. FIG. 38A illustrates an example where the right-bottom region 3812 is outside and adjacent to the current chroma block 3810. FIG. 38B illustrates an example where the right-bottom region 3822 is within the current chroma block 3820.
The prediction of the current block is generated bi-directionally by referencing original L neighbouring region (original top and left region, obtained using a traditional intra prediction mode) and the proposed inverse-L region (obtained using LM).

In one sub-embodiment, the predictors from the original top and left region and the predictors from bottom and left region are combined with weighting. In one example, equal weights are applied to both. In another example, weights vary with neighbouring coding information, sample position, block width, height, mode or area. For example, when the sample position is far from the top and left region, the weight for the prediction from the traditional intra prediction mode decreases.

In another embodiment, this proposed method can be applied to inverse LM. Then, when doing luma intra prediction, the final prediction is bi-directional, which is similar to the above example for a chroma block.

In another embodiment, after doing segmentation to know the curve pattern for luma, the proposed LM assisted Angular/Planar Mode assists chroma with getting the correct curved angle.

The proposed methods in this disclosure can be enabled and/or disabled according to implicit rules (e.g. block width, height, or area) or according to explicit rules (e.g. syntax in block, slice, picture, SPS, or PPS level).

The term “block” in this disclosure can refer to TU/TB, CU/CB, PU/PB, or CTU/CTB.

The term “LM” in this disclosure can be viewed as one kind of CCLM/MMLM modes or any other extension/variation of CCLM (e.g. the proposed CCLM extension/variation in this disclosure). While linear model for cross-component prediction has been used to illustrates embodiments of the present invention as shown above, the present invention is not limited to the linear model. Instead, any cross-component (cross-colour) prediction model may be used to practice the present invention. The following shows an example of the cross-component mode being convolutional cross-component mode (CCCM). It can be viewed as an optional mode of CCLM. When this optional mode is applied to the current block, cross-component information with one or more models, including the linear term and/or non-linear term, is used to generate the chroma prediction. Similar to CCLM, the optional mode of CCCM may follow the template selection of CCLM, so CCCM family includes CCCM_LT CCCM_L, and/or CCCM_T. Also, the optional mode of CCCM uses a single model or multi-model variation of CCCM.

The proposed methods (for CCLM) in this disclosure can be used for any other LM modes.

Any combination of the proposed methods in this disclosure can be applied. For an example of combining the proposed methods in using cross-colour tools to improve inter or intra block copy and the mentioned sub-partition scheme, when the block width, block height, or block area of the current second colour (chroma) block is larger than a pre-defined threshold, the current chroma block is first split into sub-partitions and each sub-partition can use the proposed methods in the sub-section entitled: CCLM for Inter Block to generate the hypothesis of cross-colour prediction. For a sub-partition of the current chroma block, the model parameters are derived by using reconstructed samples neighbouring to the current sub-partition, reconstructed samples neighbouring to the collocated first colour block, predicted samples (generated by a target mode) in the current sub-partition, predicted samples (generated by a target mode) or reconstructed samples in the collocated first colour block or any subset or extension from the above-mentioned samples. As the mentioned sub-partition scheme in the sub-section entitled: Intra Sub-partitions, a minimum sub-partition size is pre-defined and the width, height, or area of the sub-partition cannot be smaller than the pre-defined sub-partition size. When splitting the current block into sub-partitions and the minimum sub-partition size is met, the splitting is terminated.

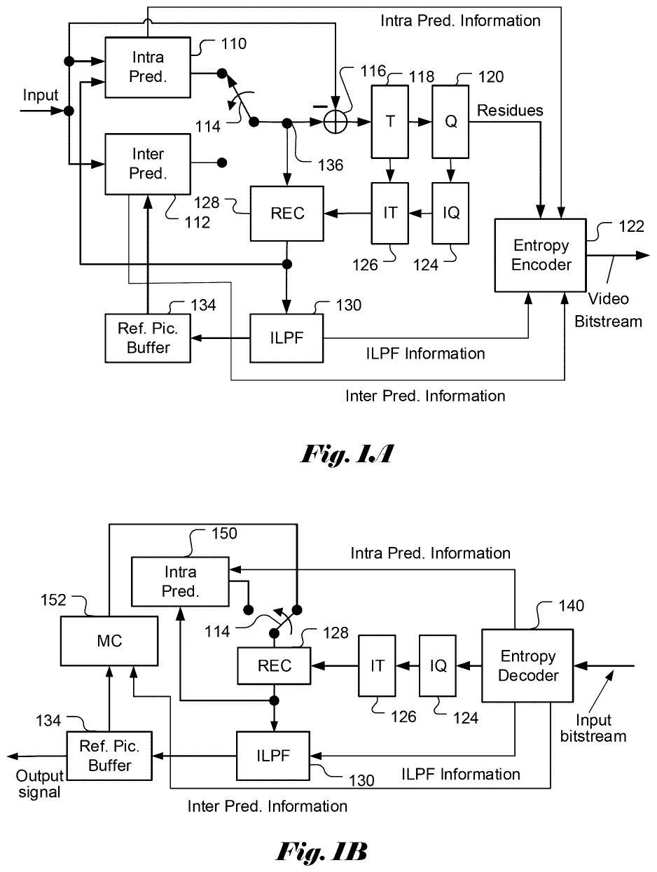

Any of the foregoing proposed cross component methods (e.g. CCLM and inter CCLM methods) can be implemented in encoders and/or decoders. For example, any of the proposed methods can be implemented in an intra/inter coding module (e.g. Intra Pred. 110 and Inter Pred. 112 in FIG. 1A) of an encoder, a motion compensation module (e.g., MC 152 in FIG. 1B), or a merge candidate derivation module of a decoder. Alternatively, any of the proposed methods can be implemented as a circuit coupled to the intra/inter coding module of an encoder and/or motion compensation module, a merge candidate derivation module of the decoder.

FIG. 39 illustrates a flowchart of an exemplary video coding system that blends a linear model predictor with an inter mode predictor according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block comprising a first-colour block and a second-colour block are received in step 3910, wherein the input data comprises pixel data for the current block to be encoded at an encoder side or encoded data associated with the current block to be decoded at a decoder side, and wherein the first-colour block is coded in a target mode and the target mode refers to an inter mode or an intra block copy mode. One or more model parameters for one or more cross-colour models associated with the first-colour block and the second-colour block are determined in step 3920. A cross-component predictor for the second-colour block is derived by applying said one or more cross-colour models to corresponding reconstructed or predicted first-colour pixels of the first-colour block in step 3930. A final predictor is derived for the second-colour block by using the cross-component predictor or combining the cross-component predictor and a target-mode predictor for the second-colour block in step 3940. The second-colour block is encoded or decoded by using prediction data comprising the final predictor in step 3950.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of prediction for colour pictures, the method comprising:
receiving input data associated with a current block comprising a first-colour block and a second-colour block, wherein the input data comprises pixel data for the current block to be encoded at an encoder side or encoded data associated with the current block to be decoded at a decoder side, and wherein the first-colour block is coded in a target mode and the target mode refers to an inter mode or an intra block copy mode;
determining one or more model parameters for one or more cross-colour models associated with the first-colour block and the second-colour block;
deriving a cross-component predictor for the second-colour block by applying said one or more cross-colour models to corresponding reconstructed or predicted first-colour pixels of the first-colour block;
deriving a final predictor for the second-colour block by using the cross-component predictor or combining the cross-component predictor and a target-mode predictor for the second-colour block; and
encoding or decoding the second-colour block by using prediction data comprising the final predictor.

2. The method of claim 1, wherein said one or more model parameters for said one or more cross-colour models are derived by using neighbouring reconstructed first-colour samples of the first-colour block and neighbouring reconstructed second-colour samples of the second-colour block.

3. The method of claim 1, wherein said one or more model parameters for said one or more cross-colour models are derived by using neighbouring predicted first-colour samples of the first-colour block and neighbouring predicted second-colour samples of the second-colour block.

4. The method of claim 1, wherein the cross-component predictor is selected from a set of cross-component modes.

5. The method of claim 4, wherein the set of cross-component modes comprises a combination of all or any subset of CCLM_LT, CCLM_L, CCLM_T, MMLM_LT, MMLM_L, and MMLM_T modes.

6. The method of claim 4, wherein the cross-component predictor is selected from the set of cross-component modes according to an implicit rule.

7. The method of claim 6, wherein the implicit rule is related to block width, block height, or block area of the current block.

8. The method of claim 6, wherein the implicit rule is inferred as predefined.

9. The method of claim 4, wherein the cross-component predictor is selected according to one or more explicit indexes.

10. The method of claim 1, wherein the target-mode predictor is derived using Combined Inter Merge and Intra Prediction (CIIP), CIIP with Template Matching (CIIP TM), or CIIP with Position Dependent Intra Prediction Combination (CIIP PDPC).

11. The method of claim 1, wherein the first-colour block corresponds to a luma block and the second-colour block corresponds to a chroma block.

12. The method of claim 1, wherein the final predictor for the second-colour block is derived using a weighted sum of the cross-component predictor and the target-mode predictor.

13. The method of claim 12, wherein one or more weights for the weighted sum of the cross-component predictor and the target-mode predictor are selected according to a coding mode of one or more neighbouring blocks of the current block.

14. The method of claim 13, wherein said one or more neighbouring blocks correspond to a top neighbouring block, a left neighbouring block or both.

15. The method of claim 1, wherein, when the current block is coded in a Combined Inter Merge and Intra Prediction (CIIP), one or more flags are signalled or parsed from a bitstream to indicate whether an cross-component process is applied to the current block, and wherein the cross-component process comprises said deriving the cross-component predictor, said deriving the final predictor and said encoding or decoding the second-colour block by using the prediction data comprising the final predictor.

16. The method of claim 15, wherein, when the cross-component process is applied to the current block, the cross-component predictor is inferred to be derived according to a pre-defined cross-component mode.

17. The method of claim 15, wherein, when the cross-component process is applied to the current block, the cross-component predictor is inferred as a target cross-component mode with a smallest boundary matching cost among a set of candidate cross-component modes.

18. An apparatus for prediction for colour pictures, the apparatus comprising one or more electronics or processors arranged to:
receive input data associated with a current block comprising a first-colour block and a second-colour block, wherein the input data comprises pixel data for the current block to be encoded at an encoder side or encoded data associated with the current block to be decoded at a decoder side, and wherein the first-colour block is coded in in a target mode and the target mode refers to an inter mode or an intra block copy mode;
determine one or more model parameters for one or more cross-colour models associated with the first-colour block and the second-colour block;
derive a cross-component predictor for the second-colour block by applying said one or more cross-colour models to corresponding reconstructed or predicted first-colour pixels of the first-colour block;
derive a final predictor for the second-colour block by using the cross-component predictor or combining the cross-component predictor and a target-mode predictor for the second-colour block; and
encode or decode the second-colour block by using prediction data comprising the final predictor.
